(19) United States
(12) Patent Application Publication
(10) Pub. No.: US 2026/0346210 A1
(43) Pub. Date: Nov. 5, 2026

(54) STACKED BODY AND FILTER ELEMENT

(71) Applicants: Sumitomo Electric Fine Polymer, Inc., Sennan-gun, Osaka (JP); Sumitomo Electric Industries, Ltd., Osaka (JP)

(72) Inventors: Hirokazu KATAYAMA, Osaka (JP); Atsushi FUKUNAGA, Osaka (JP); Hiroyuki TSUJIWAKI, Sennan-gun, Osaka (JP); Yutaro MATSUKATA, Sennan-gun, Osaka (JP); Takamasa HASHIMOTO, Sennan-gun, Osaka (JP)

(73) Assignees: Sumitomo Electric Fine Polymer, Inc., Sennan-gun, Osaka (JP); Sumitomo Electric Industries, Ltd., Osaka (JP)

(21) Appl. No.: 19/485,376

(22) PCT Filed: Apr. 18, 2024
(86) PCT No.: PCT/JP2024/015434

§ 371 Date: Nov. 18, 2025

(30) Foreign Application Priority Data
May 22, 2023 (JP) 2023-084101

(51) Int. Cl. B01D 69/02; B01D 61/14; B01D 69/10; B01D 71/36

(52) U.S. Cl. CPC B01D 69/02; B01D 69/10; B01D 71/36; B01D 61/147; B01D 2325/24

(57) ABSTRACT

A stacked body includes a porous membrane, wherein an average bubble point Pla of the stacked body is 390 kPa or more, or an average bubble point P1b of the stacked body is 780 kPa or more, a Gurley second of the stacked body is 70 seconds or less, a length X of the stacked body in an MD direction of the stacked body before a test of placing the stacked body in a thermostatic chamber at 120 °C for 1 hour and a length X′ of the stacked body in the MD direction of the stacked body after the test satisfy a relation of a formula 1, and a length Y of the stacked body in a TD direction of the stacked body before the test and a length Y′ of the stacked body in the TD direction of the stacked body after the test satisfy a relation of a formula 2.

### TECHNICAL FIELD

The present disclosure relates to a stacked body and a filter element including the stacked body. The present application claims priority based on Japanese Patent Application No. 2023-084101 filed on May 22, 2023. The entire contents of the Japanese Patent Application are incorporated herein by reference.

### BACKGROUND ART

Conventionally, each of a porous membrane (PTL 1 to PTL 5) including polytetrafluoroethylene as a main component and a stacked body (PTL 4 and PTL 5) including the porous membrane has been used as a microfiltration filter for a dispersion medium and a base substance in a semiconductor-related field or the like.

### CITATION LIST

### Patent Literature

PTL 1: Japanese Patent Laying-Open No. 2022-78151
PTL 2: Japanese Patent Laying-Open No. 2021-54892
PTL 3: WO 2007/011492
PTL 4: WO 2020/251909
PTL 5: Japanese Patent Laying-Open No. 2015-226877

### SUMMARY OF INVENTION

A stacked body according to one embodiment of the present disclosure is a stacked body comprising a porous membrane, wherein
the porous membrane includes polytetrafluoroethylene as a main component,
the stacked body has a sheet shape,
an average bubble point P1a of the stacked body is 390 kPa or more, or
an average bubble point P1b of the stacked body is 780 kPa or more,
the average bubble point P1a is measured by a bubble point method using a first-a liquid,
a surface tension of the first-a liquid is 13 mN/m,
the average bubble point P1b is measured by a bubble point method using a first-b liquid,
a surface tension of the first-b liquid is 21 mN/m,
a Gurley second of the stacked body is 70 seconds or less,
a length X of the stacked body in an MD direction of the stacked body before a test of placing the stacked body in a thermostatic chamber at 120 °C for 1 hour and a length X′ of the stacked body in the MD direction of the stacked body after the test satisfy a relation of the following formula 1, and
a length Y of the stacked body in a TD direction of the stacked body before the test and a length Y′ of the stacked body in the TD direction of the stacked body after the test satisfy a relation of the following formula 2:

|X′−X|/X≤0.10 Formula 1

|Y′−Y|/Y≤0.05 Formula 2.

### BRIEF DESCRIPTION OF DRAWINGS

FIG. 1 is a schematic enlarged cross sectional view showing an example of a stacked body according to one embodiment of the present disclosure.

FIG. 2 is a schematic enlarged cross sectional view showing another example of the stacked body according to one embodiment of the present disclosure.

FIG. 3 is a schematic enlarged cross sectional view showing still another example of the stacked body according to one embodiment of the present disclosure.

FIG. 4 is a schematic enlarged cross sectional view showing yet another example of the stacked body according to one embodiment of the present disclosure.

FIG. 5 is a perspective view of a filter element according to one embodiment of the present disclosure.

### DETAILED DESCRIPTION

### Problem to be Solved by the Present Disclosure

From the viewpoint of capturing finer particles or the like in the microfiltration for a dispersion medium and a base substance in the semiconductor-related field or the like, a stacked body including a porous membrane has been required to have a high average bubble point. It should be noted that here, the average bubble point is an index indicating how difficult it is for particles or the like to pass therethrough. As the average bubble point is higher, it is more difficult for the particles or the like to pass therethrough.

Moreover, from the viewpoint of increasing permeation efficiency in the microfiltration, it has been required to increase a flow rate of filtrate with respect to the stacked body including the porous membrane.

Further, when a stacked body including a porous membrane is used as a pleated cartridge filter, the stacked body is folded into a pleated shape, is then heated and is thermally fixed accordingly. On this occasion, when the thermal stability of the stacked body is low (in other words, when the stacked body is likely to be thermally contracted), it is likely to be difficult to perform cartridge processing and properties (pore diameter and flow rate) of the stacked body are likely to be changed, so that the stacked body is required to have excellent thermal stability. Stretched polytetrafluoroethylene is likely to be contracted intrinsically. Since the stretched polytetrafluoroethylene is heated in a sintering step to melt the polytetrafluoroethylene, internal stress generated by the stretching is released. Then, cooling and recrystallization are performed, thereby imparting thermal stability to the stretched polytetrafluoroethylene. Therefore, the stacked body including such a porous membrane including polytetrafluoroethylene as a main component has excellent thermal stability due to the sintering step. It should be noted that here, the excellent “thermal stability” means that the “contraction of the stacked body including the porous membrane due to heating” is less likely to occur.

The stacked body including the porous membrane including polytetrafluoroethylene as the main component has the excellent thermal stability due to the sintering step, but tends to have a low average bubble point and exhibit a low flow rate due to expansion of pores and decrease in porosity (in other words, a ratio of the volume of the pores with respect to the total volume of the porous membrane) each resulting from aggregation of the fiber of the porous membrane.

In view of the above, in some cases, it is difficult to achieve both excellent thermal stability and a high average bubble point in a stacked body including a porous membrane and is difficult to increase a flow rate of filtrate with respect to the stacked body.

Thus, it is an object of the present disclosure to provide: a stacked body having both excellent thermal stability and a high average bubble point and allowing for a high flow rate of filtrate; and a filter element including the stacked body.

### Advantageous Effect of the Present Disclosure

According to the present disclosure, it is possible to provide: a stacked body having both excellent thermal stability and a high average bubble point and allowing for a high flow rate of filtrate; and a filter element including the stacked body.

### DESCRIPTION OF EMBODIMENTS

First, embodiments of the present disclosure will be listed and described.
[1] A stacked body according to one embodiment of the present disclosure is a stacked body comprising a porous membrane, wherein
the porous membrane includes polytetrafluoroethylene as a main component,
the stacked body has a sheet shape,
an average bubble point P1a of the stacked body is 390 kPa or more, or
an average bubble point P1b of the stacked body is 780 kPa or more,
the average bubble point P1a is measured by a bubble point method using a first-a liquid,
a surface tension of the first-a liquid is 13 mN/m,
the average bubble point P1b is measured by a bubble point method using a first-b liquid,
a surface tension of the first-b liquid is 21 mN/m,
a Gurley second of the stacked body is 70 seconds or less,
a length X of the stacked body in an MD direction of the stacked body before a test of placing the stacked body in a thermostatic chamber at 120 °C for 1 hour and a length X′ of the stacked body in the MD direction of the stacked body after the test satisfy a relation of the following formula 1, and
a length Y of the stacked body in a TD direction of the stacked body before the test and a length Y′ of the stacked body in the TD direction of the stacked body after the test satisfy a relation of the following formula 2:

|X′−X|/X≤0.10 Formula 1

|Y′−Y|/Y≤0.05 Formula 2.

According to the present disclosure, it is possible to provide: a stacked body having both excellent thermal stability and high average bubble point and allowing for a high flow rate of filtrate; and a filter element including the stacked body.
[2] In [1], the stacked body may have a maximum tensile strength S1 in the MD direction and a maximum tensile strength S2 in the TD direction, and
the maximum tensile strength S1 in the MD direction and the maximum tensile strength S2 in the TD direction may satisfy a relation of the following formula 3:

3.2≤S1/S2≤5.0 Formula 3,

Thus, it is possible to provide: a stacked body having both more excellent thermal stability and higher average bubble point and allowing for a higher flow rate of filtrate; and a filter element including the stacked body.
[3] In [1] or [2], the stacked body may further comprise a support membrane, wherein
the support membrane may be porous, and
the support membrane may include polytetrafluoroethylene as a main component. Thus, it is possible to provide: a stacked body having both more excellent thermal stability and higher average bubble point and allowing for a higher flow rate of filtrate; and a filter element including the stacked body.
[4] In [3], the support membrane may consist of a first support membrane and a second support membrane,
the porous membrane and the second support membrane may be disposed on the first support membrane in this order, and
each of the first support membrane and the second support membrane may be a uniaxially stretched support membrane. Thus, it is possible to provide: a stacked body having both more excellent thermal stability and higher average bubble point and allowing for a higher flow rate of filtrate; and a filter element including the stacked body.
[5] In [3], the support membrane may consist of a first support membrane, a second support membrane, a third support membrane, and a fourth support membrane,
the second support membrane, the porous membrane, the third support membrane, and the fourth support membrane may be disposed on the first support membrane in this order,
each of the second support membrane and the third support membrane may be a biaxially stretched support membrane, and
each of the first support membrane and the fourth support membrane may be a uniaxially stretched support membrane. Thus, it is possible to provide: a stacked body having both more excellent thermal stability and higher average bubble point and allowing for a higher flow rate of filtrate; and a filter element including the stacked body.
[6] A filter element according to one embodiment of the present disclosure includes the stacked body according to any one of [1] to [5].

According to the present disclosure, it is possible to provide a filter element including a stacked body having both excellent thermal stability and a high average bubble point and allowing for a high flow rate of filtrate.

### Details of Embodiments of the Present Disclosure

Hereinafter, one embodiment (hereinafter, referred to as the “present embodiment”) of the present disclosure will be described. However, the present embodiment is not limited thereto. In the present specification, the expression “A to B” means the lower and upper limits of a range (i.e., A or more and B or less), and when no unit is indicated for A and a unit is indicated only for B, the unit of A and the unit of B are the same.

In the present specification, when a compound or the like is expressed by a chemical formula and an atomic ratio is not particularly limited, the atomic ratio includes all the conventionally known atomic ratios and should not be necessarily limited only to one in the stoichiometric range.

### First Embodiment: Stacked Body

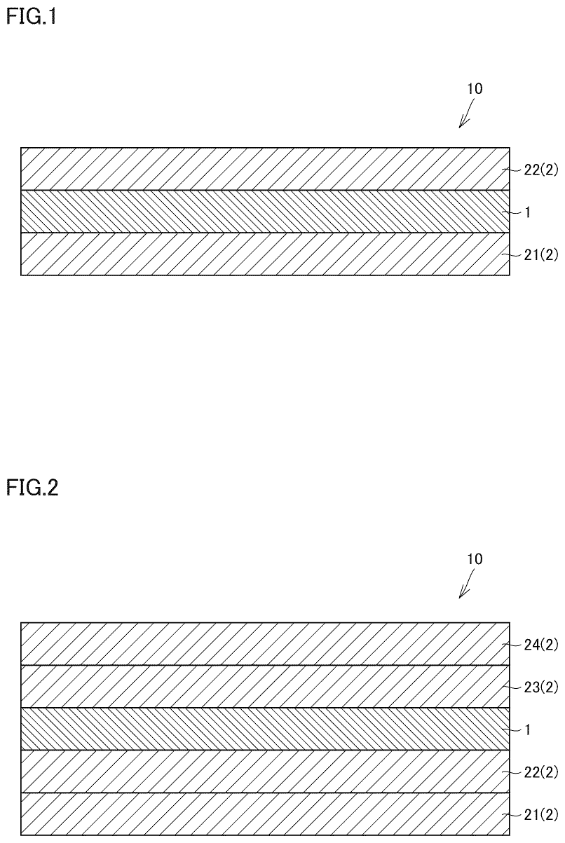

A stacked body 10 according to one embodiment of the present disclosure will be described with reference to FIGS. 1 to 4.

One embodiment of the present disclosure (hereinafter, also referred to as the “present embodiment”) is directed to a stacked body 10 comprising a porous membrane 1, wherein
porous membrane 1 includes polytetrafluoroethylene as a main component, and
stacked body 10 has a sheet shape.
(a) An average bubble point P1a of stacked body 10 is 390 kPa or more, or an average bubble point P1b of stacked body 10 is 780 kPa or more. Stacked body 10 can have a high average bubble point.

It should be noted that the average bubble point is measured by a bubble point method, and a specific liquid is used in the bubble point method. The numerical value of the average bubble point differs depending on a surface tension of the specific liquid. The “P1a” measured by a bubble point method using a “first-a liquid” and the “P1b” measured by a bubble point method using a “first-b liquid” are defined. Further, “P2a” and “P2b” described later, and “P3a” and “P3b” described later are defined.
(b) Further, a Gurley second of stacked body 10 is 70 seconds or less. Stacked body 10 can exhibit a high flow rate of filtrate.
(c) On the other hand, it tends to be difficult for such a stacked body 10 to have excellent thermal stability in relation with “ease of contraction of the fiber of the stacked body” due to residual stress of the stacked body.

In stacked body 10 of the present disclosure, a length X of stacked body 10 in an MD (Machine Direction) direction of stacked body 10 before a test of placing stacked body 10 in a thermostatic chamber at 120 °C for 1 hour and a length X′ of stacked body 10 in the MD direction of stacked body 10 after the test satisfy a relation of the following formula 1, and
a length Y of stacked body 10 in a TD (Transverse Direction) direction of stacked body 10 before the test and a length Y′ of stacked body 10 in the TD direction of stacked body 10 after the test satisfy a relation of the formula 2:

|X′−X|/X≤0.10 Formula 1

|Y′−Y|/Y≤0.05 Formula 2.

Thus, deformation of the fiber of the porous membrane due to heating is suppressed, with the result that stacked body 10 can have excellent thermal stability without impairing the high average bubble point and the high flow rate of filtrate.

### <<Stacked Body>>

### <Structure of Stacked Body>

Stacked body 10 includes porous membrane 1. Stacked body 10 may further include support membrane 2. Thus, support membrane 2 functions as a protective member for porous membrane 1, with the result that the capturing performance of stacked body 10 can be improved and the mechanical strength of stacked body 10 and the life of stacked body 10 can be improved.

Support membrane 2 can consist of, for example, a first support membrane 21 and a second support membrane 22, and a form (Form 1) can be employed in which porous membrane 1 and second support membrane 22 are disposed on first support membrane 21 in this order. Alternatively, support membrane 2 can consist of a first support membrane 21, a second support membrane 22, a third support membrane 23, and a fourth support membrane 24, and a form (Form 2) can be employed in which second support membrane 22, porous membrane 1, third support membrane 23, and fourth support membrane 24 are disposed on first support membrane 21 in this order. Alternatively, porous membrane 1 can consist of a first porous membrane and a second porous membrane, support membrane 2 can consist of a first support membrane 21, a second support membrane 22, a third support membrane 23, a fourth support membrane 24, and a fifth support membrane 25, and a form (Form 3) can be employed in which second support membrane 22, the first porous membrane, third support membrane 23, the second porous membrane, fourth support membrane 24, and fifth support membrane 25 are disposed on first support membrane 21 in this order. Alternatively, porous membrane 1 can consist of a first porous membrane, a second porous membrane, and a third porous membrane, support membrane 2 can consist of a first support membrane 21, a second support membrane 22, a third support membrane 23, a fourth support membrane 24, a fifth support membrane 25, and a sixth support membrane 26, and a form (Form 4) can be employed in which second support membrane 22, the first porous membrane, third support membrane 23, the second porous membrane, fourth support membrane 24, the third porous membrane, fifth support membrane 25, and sixth support membrane 26 are disposed on first support membrane 21 in this order. Further, support membrane 2 may be one of a uniaxially stretched support membrane described later or a biaxially stretched support membrane described later.

Stacked body 10 has a sheet shape. Here, the “sheet shape” means a thin plate shape. The thickness of stacked body 10 may be 0.010 mm or more and 0.200 mm or less. When the thickness is less than 0.010 mm, the strength of stacked body 10 tends to be insufficient. When the thickness is more than 0.200 mm, pressure loss during permeation of the filtrate tends to be large. The lower limit of the thickness of stacked body 10 may be 0.010 mm or more, 0.013 mm or more, or 0.015 mm or more. The upper limit of the thickness of stacked body 10 may be 0.200 mm or less, 0.150 mm or less, or 0.100 mm or less. The thickness of stacked body 10 may be 0.013 mm or more and 0.150 mm or less, or may be 0.015 mm or more and 0.100 mm or less. Stacked body 10 has an elongated shape.

The thickness of stacked body 10 can be specified in the same manner as in a below-described method of measuring the “thickness of porous membrane 1” except that the measurement is performed onto stacked body 10. It should be noted that it has been confirmed that the same results are obtained even when different measurement locations are freely selected in the same stacked body 10 and the above-described measurement is performed in the measurement locations.

### <Length in MD Direction and Length in TD Direction>

The length X of stacked body 10 in the MD direction of stacked body 10 before performing the test of placing stacked body 10 in the thermostatic chamber at 120 °C for 1 hour is not particularly limited as long as the relation of the formula 1 is satisfied, and can be, for example, 0.010 m or more and 1.000 m or less, 0.020 m or more and 0.500 m or less, or 0.025 m or more and 0.250 m or less. It should be noted that in the present embodiment, the “MD direction” can be also referred to as an elongation direction.

The length X of stacked body 10 in the MD direction of stacked body 10 can be specified by the following method. First, stacked body 10 before the test of placing stacked body 10 in the thermostatic chamber at 120 °C for 1 hour is prepared. Next, the length of stacked body 10 in the MD direction of stacked body 10 is measured at any five locations. Next, by calculating the average value of the lengths in the MD direction, the length X of stacked body 10 in the MD direction can be determined.

The length X′ of stacked body 10 in the MD direction of stacked body 10 after performing the test of placing stacked body 10 in the thermostatic chamber at 120 °C for 1 hour is not particularly limited as long as the relation of the formula 1 is satisfied, and can be, for example, 0.010 m or more and 1.000 m or less, 0.020 m or more and 0.500 m or less, or 0.025 m or more and 0.250 m or less.

The length X′ of stacked body 10 in the MD direction of stacked body 10 can be specified in the same manner as the “length X of stacked body 10 in the MD direction of stacked body 10” except that the measurement is performed onto “stacked body 10 after performing the test of placing stacked body 10 in the thermostatic chamber at 120 °C for 1 hour”.

The length Y of stacked body 10 in the TD direction of stacked body 10 before performing the test of placing stacked body 10 in the thermostatic chamber at 120 °C for 1 hour is not particularly limited as long as the relation of the formula 2 is satisfied, and can be, for example, 0.010 m or more and 1.000 m or less, 0.020 m or more and 0.500 m or less, or 0.025 m or more and 0.250 m or less. It should be noted that in the present embodiment, the “TD direction” of stacked body 10 is a direction perpendicular to the “MD direction” and the thickness direction of stacked body 10.

The length Y of stacked body 10 in the TD direction of stacked body 10 can be specified by the following method. First, stacked body 10 before performing the test of placing stacked body 10 in the thermostatic chamber at 120 °C for 1 hour is prepared. Next, the length of stacked body 10 in the TD direction of stacked body 10 is measured at five any locations. Next, by calculating the average value of the lengths in the TD direction, the length Y of stacked body 10 in the TD direction of stacked body 10 can be determined.

The length Y′ of stacked body 10 in the TD direction of stacked body 10 after performing the test of placing stacked body 10 in the thermostatic chamber at 120 °C for 1 hour is not particularly limited as long as the relation of the formula 2 is satisfied, and can be, for example, 0.010 m or more and 1.000 m or less, 0.020 m or more and 0.500 m or less, or 0.025 m or more and 0.250 m or less.

The length Y′ of stacked body 10 in the MD direction of stacked body 10 can be specified in the same manner as the “length Y of stacked body 10 in the TD direction of stacked body 10” except that the measurement is performed onto “stacked body 10 after performing the test of placing stacked body 10 in the thermostatic chamber at 120 °C for 1 hour”.

The length X of stacked body 10 in the MD direction of stacked body 10 before the test of placing stacked body 10 in the thermostatic chamber at 120 °C for 1 hour and the length X′ of stacked body 10 in the MD direction of stacked body 10 after the test satisfy the relation of the following formula 1, and the length Y of stacked body 10 in the TD direction of stacked body 10 before the test and the length Y′ of stacked body 10 in the TD direction of stacked body 10 after the test satisfy the relation of the formula 2:

|X′−X|/X≤0.10 Formula 1

|Y′−Y|/Y≤0.05 Formula 2.

Thus, stacked body 10 can have excellent thermal stability without impairing high average bubble point and high flow rate of filtrate.

The upper limit of “|X′-X|/X” may be 0.09 or less, 0.08 or less, or 0.07 or less. The lower limit of “|X′-X|/X” may be 0.01 or more, 0.02 or more, or 0.03 or more. “|X′-X|/X” may be 0.01 or more and 0.10 or less, 0.02 or more and 0.09 or less, or 0.03 or more and 0.08 or less.

The upper limit of |Y′-Y|/Y may be 0.09 or less, 0.08 or less, or 0.07 or less. The lower limit of |Y′-Y|/Y may be 0.01 or more, 0.02 or more, or 0.03 or more. |Y′-Y|/Y may be 0.01 or more and 0.10 or less, may be 0.02 or more and 0.09 or less, and may be 0.03 or more and 0.08 or less.

### <Density>

The density of stacked body 10 may be 0.10 g/cm³ or more and 2.00 g/cm³ or less. When the density is less than 0.10 g/cm³, the strength of stacked body 10 tends to be insufficient. When the density is more than 2.00 g/cm³, the permeation efficiency of stacked body 10 tends to be decreased. The lower limit of the density of stacked body 10 may be 0.10 g/cm³ or more, 0.13 g/cm³ or more, or 0.15 g/cm³ or more. The upper limit of the density of stacked body 10 may be 2.00 g/cm³ or less, 1.70 g/cm³ or less, or 1.50 g/cm³ or less. The density of stacked body 10 may be 0.13 g/cm³ or more and 1.70 g/cm³ or less, or may be 0.15 g/cm³ or more and 1.50 g/cm³ or less.

The density of stacked body 10 can be specified in the same manner as in a below-described method of measuring the “density of porous membrane 1” except that the measurement is performed onto “stacked body 10”. It should be noted that it has been confirmed that the same results are obtained even when different measurement ranges are freely selected in the same stacked body 10 and the above-described measurement is performed in the measurement ranges.

### <Basis Weight>

The basis weight of stacked body 10 may be 0.005 mg/mm² or more and 0,100 mg/mm² or less. When the basis weight of stacked body 10 is less than 0.005 mg/mm², the strength of stacked body 10 tends to be insufficient. When the basis weight of stacked body 10 is more than 0.100 mg/mm², the permeation efficiency of stacked body 10 tends to be decreased. The lower limit of the basis weight of stacked body 10 may be 0.005 mg/mm² or more, 0.007 mg/mm² or more, or 0.008 mg/mm² or more. The upper limit of the basis weight of stacked body 10 may be 0.100 mg/mm² or less, 0.080 mg/mm² or less, or 0.060 mg/mm² or less. The basis weight of stacked body 10 may be 0.007 mg/mm² or more and 0.080 mg/mm² or less, or may be 0.008 mg/mm² or more and 0.060 mg/mm² or less.

The basis weight of stacked body 10 can be specified in the same manner as in a below-described method of measuring the “basis weight of porous membrane 1” except that the measurement is performed onto “stacked body 10”. It should be noted that it has been confirmed that the same results are obtained even when different measurement ranges are freely selected in the same stacked body 10 and the above-described measurement is performed in the measurement ranges.

### <Average Bubble Point>

The average bubble point P1a of stacked body 10 is 390 kPa or more, and the average bubble point P1b of stacked body 10 is 780 kPa or more. The average bubble point P1a is measured by the bubble point method using the first-a liquid, and the surface tension of the first-a liquid is 13 mN/m. The average bubble point P1b is measured by the bubble point method using the first-b liquid, and the surface tension of the first-b liquid is 21 mN/m. Stacked body 10 can have a high average bubble point. The lower limit of the average bubble point P1a of stacked body 10 may be 400 kPa or more, 410 kPa or more, or 420 kPa or more. The upper limit of the average bubble point P1a of stacked body 10 may be 900 kPa or less, 890 kPa or less, or 880 kPa or less. The average bubble point P1a of stacked body 10 may be 390 kPa or more and 900 kPa or less, 400 kPa or more and 890 kPa or less, or 410 kPa or more and 880 kPa or less.

More specifically, in stacked body 10, the average bubble point P1a is specified by the following method. That is, the average bubble point P1a is specified in the same manner as in a below-described method of measuring the “average bubble point P2a of porous membrane 1” except that the measurement is performed onto “stacked body 10”.

The lower limit of the average bubble point P1b of stacked body 10 may be 790 kPa or more, 800 kPa or more, or 810 kPa or more. The upper limit of the average bubble point P1b of stacked body 10 may be 1400 kPa or less, 1390 kPa or less, or 1380 kPa or less. The average bubble point P1b of stacked body 10 may be 780 kPa or more and 1400 kPa or less, 790 kPa or more and 1390 kPa or less, or 800 kPa or more and 1380 kPa or less.

More specifically, in stacked body 10, the average bubble point P1b is specified by the following method. That is, the average bubble point P1b is specified in the same manner as in a below-described method of measuring the “average bubble point P2b of porous membrane 1” except that the measurement is performed onto “stacked body 10”.

### <Gurley Second>

The Gurley second of stacked body 10 is 70 seconds or less. Thus, the flow rate of the filtrate can be high, with the result that the permeation efficiency can be high. The lower limit of the Gurley second of stacked body 10 may be 1 second or more, 3 seconds or more, or 5 seconds or more. The upper limit of the Gurley second of stacked body 10 may be 45 seconds or less, 40 seconds or less, or 35 seconds or less. The Gurley second of stacked body 10 may be 1 second or more and 68 seconds or less, may be 3 seconds or more and 66 seconds or less, and may be 5 seconds or more and 40 seconds or less.

The Gurley second of stacked body 10 is specified by the following method. That is, the Gurley second can be specified in the same manner as in a below-described method of measuring the “Gurley second of porous membrane 1” except that the measurement is performed onto “stacked body 10”.

### <Mean Flow Pore Diameter>

The mean flow pore diameter of stacked body 10 may be 25 nm or more and 100 nm or less. Thus, stacked body 10 can have both a higher average bubble point and allows for a higher flow rate of filtrate. The lower limit of the mean flow pore diameter may be 25 nm or more, 26 nm or more, or 27 nm or more. The upper limit of the mean flow pore diameter may be 100 nm or less, 60 nm or less, or 55 nm or less. The mean flow pore diameter may be 26 nm or more and 60 nm or less, or may be 27 nm or more and 55 nm or less.

The mean flow pore diameter of stacked body 10 can be specified in the same manner as in a below-described method of measuring the “mean flow pore diameter of porous membrane 1” except that the measurement is performed onto “stacked body 10”.

### <Maximum Tensile Strength>

Stacked body 10 may have a maximum tensile strength S1 in the MD direction and a maximum tensile strength S2 in the TD direction, and the maximum tensile strength S1 in the MD direction and the maximum tensile strength S2 in the TD direction may satisfy a relation of the following formula 3:

3.2≤S1/S2≤5.0 Formula 3,

Thus, deformation of the fiber of porous membrane 1 due to heating is suppressed, with the result that stacked body 10 can have both more excellent thermal stability and higher average bubble point, and can exhibit a higher flow rate of filtrate.

In stacked body 10, the maximum tensile strength S1 in the MD direction can be specified by the following method. First, stacked body 10 is cut at any one location to have a rectangular shape of 50 mm in the MD direction×5 mm in the TD direction, thereby obtaining a sample having a rectangular shape of 50 mm in the MD direction×5 mm in the TD direction. An autograph “AGS-X” (trademark) provided by Shimadzu Corporation is used to pull the sample in the MD direction at a chuck interval of 10 mm and a rate of 100 mm/min, thereby measuring, as the maximum tensile strength S1 in the MD direction, the maximum tensile stress value applied until the sample is broken. Moreover, in stacked body 10, the maximum tensile strength S2 in the TD direction can be specified by the following method. The maximum tensile strength S2 in the TD direction can be specified in the same manner as in the method of measuring the maximum tensile strength S1 in the MD direction, except that the “pulling is performed in the TD direction” and the “maximum tensile stress value applied until the sample is broken is measured as the maximum tensile strength S2 in the TD direction”.

### <<Porous Membrane>>

### <Composition>>

Porous membrane 1 includes polytetrafluoroethylene as a main component. It should be noted that here, the “main component” means a component having the largest content in terms of mass, such as a component having a content of 90 mass % or more, preferably 95 mass % or more. Porous membrane 1 may consist of polytetrafluoroethylene. It should be noted that the expression “porous membrane 1 consists of polytetrafluoroethylene” means that porous membrane 1 can include an inevitable impurity as long as the effect of the present disclosure is exhibited. Further, in the present application, the “polytetrafluoroethylene” is a polymer of tetrafluoroethylene, and represents a concept including a homopolymer of tetrafluoroethylene and a modified substance of the “homopolymer of tetrafluoroethylene”. Examples of the modified substance include: a tetrafluoroethylene-hexafluoropropylene copolymer (in other words, perfluoroethylene propene copolymer; hereinafter, also referred to as “FEP”); a tetrafluoroethylene-perfluoroalkyl vinyl ether copolymer (PFA); an ethylene-tetrafluoroethylene copolymer (ETFE); and the like. The modified substance can include 0.1 mol % or less of hexafluoropropylene (HFP), perfluoro (alkyl vinyl ether) (FVE), or the like.

In porous membrane 1, the content of the polytetrafluoroethylene can be specified based on an absorbance of “—CF₂—” indicating tetrafluoroethylene (TFE) at an absorption wavelength of 4.25 μm, an absorbance of “—CH₃ group” indicating FEP at an absorption wavelength of 10.18 μm, an absorbance of “CF₃O— group” indicating PFA at an absorption wavelength of 10.07 μm, and the like. It should be noted that it has been confirmed that the same results are obtained even when different measurement ranges are freely selected in the same porous membrane 1.

### <Shape>

The thickness of porous membrane 1 may be 0.002 mm or more and 0.100 mm or less. When the thickness is less than 0.002 mm, the strength of porous membrane 1 tends to be insufficient. When the thickness is more than 0.100 mm, pressure loss during permeation of a filtrate tends to be large. The lower limit of the thickness of porous membrane 1 may be 0.002 mm or more, 0.005 mm or more, or 0.010 mm or more. The upper limit of the thickness of porous membrane 1 may be 0.100 mm or less, 0.090 mm or less, or 0.080 mm or less. The thickness of porous membrane 1 may be 0.005 mm or more and 0.090 mm or less, or may be 0.010 mm or more and 0.080 mm or less.

The thickness of porous membrane 1 can be specified by the following method. First, a thickness thereof at any one location is measured using a standard type digital thickness gauge. Then, the standard type digital thickness gauge is used to measure thicknesses thereof at any other nine locations. Next, the average value of the thicknesses at the total of ten locations is calculated, thereby specifying the thickness of porous membrane 1.

It should be noted that it has been confirmed that the same results are obtained even when different measurement locations are freely selected in the same porous membrane 1 and the above-described measurement is performed in the measurement locations.

### <Density>

The density of porous membrane 1 may be 0.05 g/cm³ or more and 2.00 g/cm³ or less. When the density is less than 0.05 g/cm³, the strength of porous membrane 1 tends to be insufficient. When the density is more than 2.00 g/cm³, the permeation efficiency of porous membrane 1 tends to be decreased. The lower limit of the density of porous membrane 1 may be 0.05 g/cm³ or more, 0.10 g/cm³ or more, or 0.15 g/cm³ or more. The upper limit of the density of porous membrane 1 may be 2.00 g/cm³ or less, 1.70 g/cm³ or less, or 1.50 g/cm³ or less. The density of porous membrane 1 may be 0.10 g/cm³ or more and 1.70 g/cm³ or less, or may be 0.15 g/cm³ or more and 1.50 g/cm³ or less.

The density of porous membrane 1 can be specified by the following method. That is, the density of porous membrane 1 can be calculated based on the formula “Density [g/cm³]=[{(basis weight [mg/mm²])/1000}/{(thickness [mm])/10}]/(1/100)”, the numerical value of the basis weight, and the numerical value of the thickness.

### <Basis Weight>

The basis weight of porous membrane 1 may be 0.002 mg/mm² or more and 0.100 mg/mm² or less. When the basis weight of porous membrane 1 is less than 0.002 mg/mm², the strength of porous membrane 1 tends to be insufficient. When the basis weight of porous membrane 1 is more than 0.100 mg/mm², the permeation efficiency of porous membrane 1 tends to be decreased. The lower limit of the basis weight of porous membrane 1 may be 0.002 mg/mm² or more, 0.003 mg/mm² or more, or 0.004 mg/mm² or more. The upper limit of the basis weight of porous membrane 1 may be 0.100 mg/mm² or less, 0.080 mg/mm² or less, or 0.060 mg/mm² or less. The basis weight of porous membrane 1 may be 0.003 mg/mm² or more and 0.080 mg/mm² or less, or may be 0.004 mg/mm² or more and 0.060 mg/mm² or less.

The basis weight of porous membrane 1 can be specified by the following method. First, porous membrane 1 is punched out at any one location thereof in the membrane thickness direction to have a diameter of 60 mm, thereby obtaining an evaluation sample. Next, the mass [g] of the evaluation sample is measured using an analytical balance “AP224X” (trademark) provided by Shimadzu Corporation. Next, the basis weight of porous membrane 1 is calculated based on the mass and the following formula: “the basis weight [mg/mm²]={1000×(the mass [g] of the evaluation sample)}/{(60/2)²×π}”.

It should be noted that it has been confirmed that the same results are obtained even when different measurement ranges are freely selected in the same porous membrane 1 and the above-described measurement is performed in the measurement ranges.

### <Average Bubble Point>

The average bubble point P2a of porous membrane 1 may be 300 kPa or more and 900 kPa or less, or the average bubble point P2b of porous membrane 1 may be 780 kPa or more and 1400 kPa or less. Thus, stacked body 10 can have a higher average bubble point and a higher flow rate of filtrate. The lower limit of the average bubble point P2a of porous membrane 1 may be 300 kPa or more, 310 kPa or more, or 320 kPa or more. The upper limit of average bubble point P2a of porous membrane 1 may be 900 kPa or less, 890 kPa or less, or 880 kPa or less. The average bubble point P2a of porous membrane 1 may be 310 kPa or more and 890 kPa or less, and may be 320 kPa or more and 880 kPa or less.

The average bubble point P2a of porous membrane 1 is measured by the bubble point method using the first-a liquid, and the surface tension of the first-a liquid is 13 mN/m. More specifically, the average bubble point of porous membrane 1 is specified by the following method. First, for porous membrane 1 in a dry state, differential pressure applied to porous membrane 1 and an air flow rate through porous membrane 1 are measured based on the bubble point method (ASTM F316-86; JIS K3832). Next, in coordinates in which the horizontal axis represents the differential pressure and the vertical axis represents the air flow rate, a first curve is obtained which indicates a relation between the differential pressure and a numerical value obtained by dividing the air flow rate by 2. Next, porous membrane 1 is immersed for about 5 minutes at about 25 °C in “Opteon SF70” (trademark), which is a hydrofluoroolefin (first-a liquid) provided by Chemours-Mitsui Fluoroproducts, and is taken out from the hydrofluoroolefin (first-a liquid), thereby obtaining porous membrane 1 wetted with the hydrooroolefin (first-a liquid). Next, for porous membrane 1 wetted with the hydrofluoroolefin (first-a liquid), the differential pressure applied to porous membrane 1 and the air flow rate through porous membrane 1 are measured based on the bubble point method. Next, in the coordinates in which the horizontal axis represents the differential pressure and the vertical axis represents the air flow rate, a second curve is obtained which indicates a relation between the differential pressure and the air flow rate. Next, a differential pressure at the intersection between the first curve and the second curve is specified as the average bubble point P2a of porous membrane 1.

The lower limit of the average bubble point P2b of porous membrane 1 may be 780 kPa or more, 790 kPa or more, or 800 kPa or more. The upper limit of the average bubble point P2b of porous membrane 1 may be 1400 kPa or less, 1390 kPa or less, or 1380 kPa or less. The average bubble point P2b of porous membrane 1 may be 790 kPa or more and 1390 kPa or less, and may be 800 kPa or more and 1380 kPa or less.

In porous membrane 1, the average bubble point P2b is measured by the bubble point method using the first-b liquid, and the surface tension of the first-b liquid is 21 mN/m. More specifically, in porous membrane 1, the average bubble point P2b is specified in the same manner as in the method of measuring the P2a except that isopropyl alcohol (first-b liquid) provided by FUJIFILM Wako Pure Chemical Corporation is used instead of the first-a liquid.

### <Gurley Second>

The Gurley second of porous membrane 1 may be 1 second or more and 100 seconds or less. Thus, the flow rate of the filtrate can be high, with the result that the permeation efficiency can be high and the capturing performance for fine particles included in the filtrate can be high. The lower limit of the Gurley second of porous membrane 1 may be 1 second or more, 3 seconds or more, or 5 seconds or more. The upper limit of the Gurley second of porous membrane 1 may be 100 seconds or less, 80 seconds or less, or 60 seconds or less. The Gurley second of porous membrane 1 may be 3 seconds or more and 80 seconds or less, or may be 5 seconds or more and 60 seconds or less.

The Gurley second of porous membrane 1 can be specified by the following method. That is, in accordance with JIS P 8117, a time required for 100 ml of air to pass through a membrane effective area of 6.42 cm² at a differential pressure of 1.22 kPa is measured. The time is defined as the Gurley second of porous membrane 1.

### <Mean Flow Pore Diameter>

The mean flow pore diameter of porous membrane 1 may be 25 nm or more and 70 nm or less. Thus, stacked body 10 can have a higher average bubble point and a higher flow rate of filtrate. The lower limit of the mean flow pore diameter may be 25 nm or more, 26 nm or more, or 27 nm or more. The upper limit of the mean flow pore diameter may be 70 nm or less, 67 nm or less, or 65 nm or less. The mean flow pore diameter may be 26 nm or more and 67 nm or less, or may be 27 nm or more and 65 nm or less.

The mean flow pore diameter of porous membrane 1 can be specified by the following measurement method. That is, first, for porous membrane 1 in a dry state, a differential pressure applied to porous membrane 1 and an air flow rate through porous membrane 1 are measured based on the bubble point method. Next, in coordinates in which the horizontal axis represents the differential pressure and the vertical axis represents the air flow rate, a third curve is obtained which indicates a relation between the differential pressure and a numerical value obtained by dividing the air flow rate by 2. Next, porous membrane 1 is immersed at about 25 °C for about 5 minutes in GALWICK (propylene, 1,1,2,3,3,3-oxidized hexahydrofluoric acid; fourth liquid) provided by Porous Materials Inc., and is taken out from the GALWICK (fourth liquid), thereby obtaining porous membrane 1 wetted with the GALWICK (fourth liquid). Next, for porous membrane 1 wetted with the GALWICK (fourth liquid), the differential pressure applied to porous membrane 1 and the air flow rate through porous membrane 1 are measured based on the bubble point method. Next, in the coordinates in which the horizontal axis represents the differential pressure and the vertical axis represents the air flow rate, a fourth curve is obtained which indicates a relation between the differential pressure and the air flow rate. Next, a differential pressure P′ at the intersection between the third curve and the fourth curve is specified. Next, by dividing the product of a constant of 2860 and the surface tension of 16 mN of the fourth liquid by differential pressure P′, the mean flow pore diameter [nm] of porous membrane 1 is determined. It should be noted that in the bubble point method, for example, a perm porometer “CFP-1500A” provided by PMI is used as a pore diameter distribution measurement device.

### <<Support Membrane>>

### <Structure>

Support membrane 2 is porous. Here, “porous” means inclusion of a fibrous framework in which pores are connected in the form of a three-dimensional mesh. It should be noted that the mean flow pore diameter of support membrane 2 may be larger than the mean flow pore diameter of porous membrane 1, and support membrane 2 may not excessively inhibit the permeation efficiency of porous membrane 1. The fact “support membrane 2 is porous” can be specified by observing a surface state or a cross section state of support membrane 2 using a scanning electron microscope.

The thickness of support membrane 2 may be 0.002 mm or more and 0.050 mm or less. When the thickness of support membrane 2 is less than 0.002 mm, the function as a protective member for porous membrane 1 tends to be less likely to be exhibited, and the mechanical strength of stacked body 10 and the life of stacked body 10 tend to be less likely to be increased. When the thickness of support membrane 2 is more than 0.050 mm, both the capturing performance of stacked body 10 and the permeation efficiency of stacked body 10 tend to be less likely to be achieved by support membrane 2. The lower limit of the thickness may be 0.002 mm or more, 0.004 mm or more, or 0.006 mm or more. The upper limit of the thickness may be 0.050 mm or less, 0.045 mm or less, or 0.040 mm or less. The thickness may be 0.004 mm or more and 0.045 mm or less, or may be 0.006 mm or more and 0.040 mm or less. In Forms 1 to 4, the thicknesses of the first to sixth support membranes can be in the above ranges.

The thickness of support membrane 2 can be specified in the same manner as in the above-described method of measuring the “thickness of porous membrane 1” except that the measurement is performed onto support membrane 2. It should be noted that it has been confirmed that the same results are obtained even when different measurement locations are freely selected in the same support membrane 2 and the above-described measurement is performed in the measurement locations.

### <Uniaxially Stretched Support Membrane and Biaxially Stretched Support Membrane>

Support membrane 2 may be a uniaxially stretched support membrane or a biaxially stretched support membrane. In particular, when support membrane 2 is the biaxially stretched support membrane, the fiber (polytetrafluoroethylene) of support membrane 2 and the fiber (polytetrafluoroethylene) of porous membrane 1 are facilitated to be entangled with each other, with the result that the mean flow pore diameter of stacked body 10 can be smaller (in other words, the average bubble point of stacked body 10 can be higher). In particular, when support membrane 2 is the uniaxially stretched support membrane, the fiber of support membrane 2 is oriented only in the MD direction, which is the stretching direction, with the result that the thermal stability of stacked body 10 can be higher.

When support membrane 2 consists of the first support membrane and the second support membrane, each of the first support membrane and the second support membrane may be the uniaxially stretched support membrane. Thus, deformation of the fiber of the porous membrane due to heating is suppressed, with the result that stacked body 10 can have both more excellent thermal stability and a higher average bubble point, and can exhibit a higher flow rate of filtrate.

When support membrane 2 consists of the first support membrane, the second support membrane, the third support membrane, and the fourth support membrane, each of the second support membrane and the third support membrane may be the biaxially stretched support membrane, and each of the first support membrane and the fourth support membrane may be the uniaxially stretched support membrane. Thus, deformation of the fiber of the porous membrane due to heating is suppressed, and the fibers of support membrane 2 and porous membrane 1 are facilitated to be entangled with each other, with the result that stacked body 10 can have both more excellent thermal stability and a higher average bubble point, and can exhibit a higher flow rate of filtrate.

When support membrane 2 consists of the first support membrane, the second support membrane, the third support membrane, the fourth support membrane, and the fifth support membrane, each of the second support membrane, the third support membrane, and the fourth support membrane may be the biaxially stretched support membrane, and each of the first support membrane and the fifth support membrane may be the uniaxially stretched support membrane. Thus, deformation of the fiber of the porous membrane due to heating is suppressed, and the fibers of support membrane 2 and porous membrane 1 are facilitated to be entangled with each other, with the result that stacked body 10 can have both more excellent thermal stability and a higher average bubble point, and can exhibit a higher flow rate of filtrate.

When support membrane 2 consists of the first support membrane, the second support membrane, the third support membrane, the fourth support membrane, the fifth support membrane, and the sixth support membrane, each of the second support membrane, the third support membrane, the fourth support membrane, and the fifth support membrane may be the biaxially stretched support membrane, and each of the first support membrane and the sixth support membrane may be the uniaxially stretched support membrane. Thus, deformation of the fiber of the porous membrane due to heating is suppressed, and the fibers of support membrane 2 and porous membrane 1 are facilitated to be entangled with each other, with the result that stacked body 10 can have both more excellent thermal stability and a higher average bubble point, and can exhibit a higher flow rate of filtrate.

When the uniaxially stretched support membrane has a maximum tensile strength S5 in the MD direction and a maximum tensile strength S6 in the TD direction, the expression “support membrane 2 is the uniaxially stretched support membrane” means “the maximum tensile strength S5 in the MD direction and the maximum tensile strength S6 in the TD direction satisfy a relation of the following formula 5”:

2.0≤S5/S6≤50 Formula 5.

The maximum tensile strength S5 in the MD direction and the maximum tensile strength S6 in the TD direction can be specified in the same manner as in the method of measuring “the maximum tensile strength S1 in the MD direction and the maximum tensile strength S2 in the TD direction in stacked body 10” except that the measurement is performed onto the uniaxially stretched support membrane.

When the biaxially stretched support membrane has a maximum tensile strength S3 in the MD direction and a maximum tensile strength S4 in the TD direction, the expression “support membrane 2 is the biaxially stretched support membrane” means “the maximum tensile strength S3 in the MD direction and the maximum tensile strength S4 in the TD direction satisfy a relation of the following formula 4”:

0.5≤S3/S4<2.0 Formula 4.

The maximum tensile strength S3 in the MD direction and the maximum tensile strength S4 in the TD direction can be specified in the same manner as in the method of measuring the maximum tensile strength S1 in the MD direction and the maximum tensile strength S2 in the TD direction in stacked body 10 except that the measurement is performed onto the biaxially stretched support membrane.

### <Density>

The density of support membrane 2 may be 0.10 g/cm³ or more and 2.00 g/cm³ or less. When the density is less than 0.10 g/cm³, the strength of stacked body 10 tends to be insufficient. When the density is more than 2.00 g/cm³, the permeation efficiency of stacked body 10 tends to be decreased. The lower limit of the density of support membrane 2 may be 0.10 g/cm³ or more, 0.13 g/cm³ or more, or 0.15 g/cm³ or more. The upper limit of the density of support membrane 2 may be 2.00 g/cm³ or less, 1.70 g/cm³ or less, or 1.50 g/cm³ or less. The density of support membrane 2 may be 0.13 g/cm³ or more and 1.70 g/cm³ or less, or may be 0.15 g/cm³ or more and 1.50 g/cm³ or less. In Forms 1 to 4, the densities of the first to sixth support membranes can be in the above ranges.

The density of support membrane 2 can be specified in the same manner as in the above-described method of measuring the “density of porous membrane 1” except that the measurement is performed onto “support membrane 2”. It should be noted that it has been confirmed that the same results are obtained even when different measurement ranges are freely selected in the same support membrane 2 and the above-described measurement is performed in the measurement ranges.

### <Basis Weight>

The basis weight of support membrane 2 may be 0.005 mg/mm² or more and 0.100 mg/mm² or less. When the basis weight of support membrane 2 is less than 0.005 mg/mm², the strength of stacked body 10 tends to be insufficient. When the basis weight of support membrane 2 is more than 0.100 mg/mm², the permeation efficiency of stacked body 10 tends to be decreased. The lower limit of the basis weight of support membrane 2 may be 0.005 mg/mm² or more, 0.006 mg/mm² or more, or 0.007 mg/mm² or more. The upper limit of the basis weight of support membrane 2 may be 0.100 mg/mm² or less, 0.080 mg/mm² or less, or 0.060 mg/mm² or less. The basis weight of support membrane 2 may be 0.006 mg/mm² or more and 0.080 mg/mm² or less, or may be 0.007 mg/mm² or more and 0.060 mg/mm² or less. In Forms 1 to 4, the basis weights of the first to sixth support membranes can be in the above ranges.

The basis weight of support membrane 2 can be specified in the same manner as in a below-described “method of measuring the basis weight of porous membrane 1” except that the measurement is performed onto “support membrane 2”. It should be noted that it has been confirmed that the same results are obtained even when different measurement ranges are freely selected in the same stacked body 10 and the above-described measurement is performed in the measurement ranges.

### <Average Bubble Point>

The average bubble point P3a of support membrane 2 may be 5 kPa or more and 400 kPa or less, or the average bubble point P3b of support membrane 2 may be 5 kPa or more and 800 kPa or less. Thus, stacked body 10 can have a higher average bubble point. The lower limit of the average bubble point P3a of support membrane 2 may be 5 kPa or more, 7 kPa or more, or 10 kPa or more. The upper limit of the average bubble point P3a of support membrane 2 may be 400 kPa or less, 350 kPa or less, or 300 kPa or less. The average bubble point P3a of support membrane 2 may be 7 kPa or more and 350 kPa or less, or may be 10 kPa or more and 300 kPa or less. In Forms 1 to 4, the average bubble points P3a of the first to sixth support membranes can be in the above ranges.

The average bubble point P3a of support membrane 2 is measured by the bubble point method using the first-a liquid, and the surface tension of the first-a liquid is 13 mN/m. In stacked body 10, more specifically, the average bubble point P3a is specified by the following method. That is, the average bubble point P3a is specified in the same manner as in the method of measuring the “average bubble point P2a of porous membrane 1” except that the measurement is performed onto “support membrane 2”

The lower limit of the average bubble point P3b of support membrane 2 may be 5 kPa or more, 7 kPa or more, or 10 kPa or more. The upper limit of the average bubble point P3b of support membrane 2 may be 800 kPa or less, 700 kPa or less, or 600 kPa or less. The average bubble point P3b of support membrane 2 may be 7 kPa or more and 700 kPa or less, or may be 10 kPa or more and 600 kPa or less. The above ranges can be employed.

The average bubble point P3b of support membrane 2 is measured by the bubble point method using the first-b liquid, and the surface tension of the first-b liquid is 13 mN/m. In stacked body 10, more specifically, the average bubble point P3b is specified by the following method. That is, the average bubble point P3b is specified in the same manner as in the method of measuring the “average bubble point P2b of porous membrane 1” except that the measurement is performed onto “support membrane 2”

### <Gurley Second>

The Gurley second of support membrane 2 may be 0.5 seconds or more and 60 seconds or less. Thus, the flow rate of filtrate can be higher, and the permeation efficiency can be therefore higher. The lower limit of the Gurley second of support membrane 2 may be 0.5 seconds or more, 0.7 seconds or more, or 1.0 seconds or more. The upper limit of the Gurley second of support membrane 2 may be 60 seconds or less, 50 seconds or less, or 40 seconds or less. The Gurley second of support membrane 2 may be 0.7 seconds or more and 50 seconds or less, or may be 1.0 seconds or more and 40 seconds or less. In Forms 1 to 4, the Gurley seconds of the first to sixth support membranes can be in the above ranges.

The Gurley second of support membrane 2 is specified by the following method. That is, the Gurley second can be specified in the same manner as in the method of measuring the “Gurley second of porous membrane 1” except that the measurement is performed on “support membrane 2”.

### <Mean Flow Pore Diameter>

The mean flow pore diameter of support membrane 2 may be 45 nm or more and 600 nm or less. Thus, stacked body 10 can have both excellent strength and excellent permeation efficiency. The lower limit of the mean flow pore diameter may be 45 nm or more, 50 nm or more, or 55 nm or more. The upper limit of the mean flow pore diameter may be 600 nm or less, 550 nm or less, or 500 nm or less. The mean flow pore diameter may be 50 nm or more and 550 nm or less, and may be 55 nm or more and 500 nm or less. In Forms 1 to 4, the mean flow pore diameters of the first to sixth support membranes can be in the above ranges.

The mean flow pore diameter of support membrane 2 can be specified in the same manner as in the above-described method of measuring the “mean flow pore diameter of porous membrane 1” except that the measurement is performed onto “support membrane 2”.

### <Composition>

Support membrane 2 includes polytetrafluoroethylene as a main component. Thus, the heat resistance, chemical stability, and the like of support membrane 2 can be improved. It should be noted that here, the “main component” means a component having the largest content in terms of mass, such as a component having a content of 90 mass % or more, preferably 95 mass % or more. Support membrane 2 may consist of polytetrafluoroethylene. It should be noted that the expression “support membrane 2 consists of polytetrafluoroethylene” means that support membrane 2 can include an inevitable impurity as long as the effect of the present disclosure is exhibited.

The content of polytetrafluoroethylene in support membrane 2 can be specified in the same manner as in the above-described method of measuring “the content of polytetrafluoroethylene in porous membrane 1” except that the measurement is performed onto support membrane 2. It should be noted that it has been confirmed that the same results are obtained even when different measurement ranges are freely selected in the same support membrane 2 and the above-described measurement is performed in the measurement ranges.

### Second Embodiment: Method of Producing Stacked Body

A method of producing the stacked body according to the first embodiment will be described. It should be noted that the method of producing the stacked body is not limited to the below-described method. For example, the method of producing the stacked body according to the second embodiment can include: a first step of preparing the porous membrane and the support membrane; and a second step of stacking the porous membrane and the support membrane. Further, the first step can include: a first-1 step of preparing the porous membrane; and a first-2 step of preparing the support membrane. Further, the first-1 step can include: a first-1-a step of obtaining a kneaded material of a polytetrafluoroethylene powder and a liquid lubricant; a first-1-b step of obtaining a sheet-shaped molded body through extrusion molding of the kneaded material; a first-1-c step of obtaining a stretched body by biaxially stretching the molded body; and a first-1-d step of obtaining the porous membrane by performing heat treatment onto the stretched body. Further, the first-2 step can include: a first-2-a step of obtaining a kneaded material of a polytetrafluoroethylene powder and a liquid lubricant; a first-2-b step of obtaining a sheet-shaped molded body through extrusion molding of the kneaded material; a first-2-c step of obtaining a stretched body by uniaxially or biaxially stretching the molded body; and a first-2-d step of obtaining the support membrane by performing heat treatment onto the stretched body.

### <<First Step>>

### <First-1 Step>

### (First-1-a Step)

The first-1-a step is performed by kneading the polytetrafluoroethylene powder and the liquid lubricant to obtain the kneaded material. More specifically, first, the polytetrafluoroethylene powder and the liquid lubricant are mixed to obtain a mixture. Next, the mixture is subjected to compression molding to have a block shape by using a compression molding machine, thereby obtaining the kneaded material

The polytetrafluoroethylene powder means a powder consisting of fine particles of polytetrafluoroethylene. Examples of the polytetrafluoroethylene powder include: a “PTFE (polytetrafluoroethylene) fine powder” produced by emulsion polymerization; a “PTFE molding powder” produced by suspension polymerization; and the like.

The number average molecular weight of the polytetrafluoroethylene in the polytetrafluoroethylene powder may be 12,000,000 or more and 50,000,000 or less from such a viewpoint that the pore is excessively expanded during stretching and growth of a fibrous framework can be facilitated to be promoted while preventing cleavage of the porous membrane. Moreover, a second melting heat amount in the polytetrafluoroethylene powder may be 10 J/g or more and 25 J/g or less from such a viewpoint that it depends on the number average molecular weight in the polytetrafluoroethylene powder. Here, the second melting heat amount can be specified by the following method. The polytetrafluoroethylene powder is heated from the room temperature to 380 °C at a rate of 10 °C/min (pattern 1 (1st. Run)), is then cooled from 380 °C to 100 °C at a rate of −1 °C/min (pattern 2), and is then heated from 100 °C to 380 °C at a rate of 10 °C/min (pattern 3 (2nd. Run)). An endothermic amount obtained by integrating an interval of 48 °C from an endset temperature of a peak of the melting curve of pattern 3 in a range of 300 °C or more and 360 °C or less is defined as the second melting heat amount. It should be noted that here, the “endset temperature” means a temperature of an end point of melting in response to temperature increase in a relation between the melting curve and the peak.

As the liquid lubricant, various lubricants conventionally used in an extrusion method can be used. Examples of the liquid lubricant include: a petroleum-based solvent such as solvent naphtha or white oil; hydrocarbon oil such as undecane; an aromatic hydrocarbon such as toluol or xylol; an alcohol; a ketone; an ester; silicone oil; fluorochlorocarbon oil; a solution obtained by dissolving a polymer such as polyisobutylene or polyisoprene in each of these solvents; water or an aqueous solution including a surface active agent; and the like, and these may be used solely or in the form of a mixture of two or more thereof. However, from the viewpoint of uniformity of mixing, a liquid lubricant of a single component may be used.

The parts by mass of the liquid lubricant may be 10 parts by mass or more and 40 parts by mass or less with respect to 100 parts by mass of the polytetrafluoroethylene powder. When the parts by mass of the liquid lubricant is less than 10 parts by mass, it tends to be difficult to perform extrusion. When the mass of the liquid lubricant is more than 40 parts by mass, it tends to be difficult to perform compression molding.

In addition to the polytetrafluoroethylene powder and the liquid lubricant, another additive may be further used as a material of the kneaded material. Examples of the other additive include: a pigment for coloring; an inorganic filler, such as carbon black, graphite, silica powder, glass powder, glass fiber, a silicate, or a carbonate, a metal powder, a metal oxide powder, or a metal sulfide powder for changing wear resistance, preventing low-temperature flow, or facilitating pore formation; and the like. Moreover, in order to assist formation of a porous structure, a material to be removed or decomposed by heating, extraction, melting, or the like may be used in the form of a powder or a solution, such as ammonium chloride, sodium chloride, a plastic other than polytetrafluoroethylene, or a rubber.

### <First-1-b Step>>

The first-1-b step is performed by performing extrusion-molding onto the kneaded material so as to obtain the sheet-shaped molded body. More specifically, the kneaded material is subjected to extrusion molding to have a sheet shape at a temperature of the room temperature (for example, 25 °C) or more and 50 °C or less and at a rate of, for example, 10 mm/min or more and 30 mm/min or less, thereby obtaining a precursor of the sheet-shaped molded body. Further, the precursor is subjected to rolling with a calender roll or the like, thereby obtaining the sheet-shaped molded body having an average thickness of 0.200 mm or more and 0.400 mm or less. The average thickness can be specified in the same manner as in the above-described method of measuring the “thickness of porous membrane 1” except that the measurement is performed onto the molded body.

Further, the liquid lubricant included in the molded body may be removed before the below-described first-1-c step is performed. The liquid lubricant can be removed by performing heating, extraction, melting, or the like onto the molded body. When performing the heating, for example, the liquid lubricant can be removed from the molded body by performing rolling onto the molded body using a hot roll of 130 °C or more and 220 °C or less. When a liquid lubricant having a relatively high boiling point such as silicone oil or fluorochlorocarbon oil is used as the liquid lubricant, the removal by extraction is preferable.

### <First-1-c Step>

The first-1-c step is performed by biaxially stretching the molded body so as to obtain the stretched body. Here, the biaxial stretching means stretching the sheet-shaped molded body in the MD direction (in other words, the flow direction of the molded body) and the TD direction orthogonal to the MD direction. It should be noted that here, after the stretching in the MD direction is performed, the stretching in the TD direction is performed.

The temperature in the first-1-c step may be 60 °C or more and 300 °C or less. When the temperature is more than 300 °C, the pore diameter of the porous membrane tends to be too large (in other words, the average bubble point of the porous membrane tends to be too small). When the temperature is less than 60 °C, the pore diameter tends to be too small (in other words, the average bubble point of the porous membrane tends to be too large).

A draw ratio in the MD direction may be 1.5 times or more and 20 times or less. It should be noted that the draw ratio in the MD direction means a value obtained by dividing the average length in the MD direction immediately after the stretching in the MD direction by the average length in the MD direction immediately before the stretching in the MD direction. When the draw ratio in the MD direction is less than 1.5 times, the thickness of the porous membrane may fall out of the desired range. When the draw ratio in the MD direction is more than 20 times, the thickness of the porous membrane may fall out of the desired range. It should be noted that here, the “average length in the MD direction” means the average value of lengths at any ten locations in the MD direction.

The draw ratio in the TD direction may be 1.5 times or more and 100 times or less. It should be noted that the draw ratio in the TD direction means a value obtained by dividing the average length in the TD direction immediately after the stretching in the TD direction by the average length in the TD direction immediately before the stretching in the TD direction. When the draw ratio in the TD direction is less than 1.5 times, the thickness of the porous membrane may fall out of the desired range. When the draw ratio in the TD direction is more than 100 times, the thickness of the porous membrane may fall out of the desired range. It should be noted that here, the “average length in the TD direction” means the average value of lengths at any ten locations in the TD direction.

### <First-1-d Step>

The first-1-d step is performed by performing heat treatment onto the stretched body so as to obtain the porous membrane. The first-1-d step is performed under conditions of 140 °C or more and 345 °C or less and 0.01 minute or more and 120 minutes or less.

The lower limit of the temperature in the first-1-d step may be 140 °C or more. When the temperature is less than 140 °C, stretching residual stress is not sufficiently relaxed, with the result that the stacked body tends to be likely to be thermally contracted. The upper limit of the temperature in the first-1-d step may be 345 °C or less. When the temperature is more than 345 °C, the mean flow pore diameter of the stacked body tends to be facilitated to be excessively expanded (in other words, the average bubble point of the stacked body tends to be likely to be decreased excessively).

The lower limit of the time of the first-1-d step may be 0.01 minute or more. When the time is less than 0.01 minute, the thermal stability of the stacked body tends to be facilitated to be insufficient. The upper limit of the time of the first-1-d step may be 120 minutes or less. When the time is more than 120 minutes, the mean flow pore diameter of the stacked body tends to be facilitated to be excessively expanded (in other words, the average bubble point of the stacked body tends to be facilitated to be decreased excessively).

### <First-2 Step>

### (First-2-a Step)

The first-2-a step is performed by kneading the polytetrafluoroethylene powder and the liquid lubricant to obtain the kneaded material. More specifically, first, the polytetrafluoroethylene powder and the liquid lubricant are mixed to obtain a mixture. Next, the mixture is subjected to compression molding to have a block shape by using a compression molding machine, thereby obtaining the kneaded material.

Examples of the polytetrafluoroethylene powder include “CD145E” (trademark) provided by AGC, “CD123E” (trademark) provided by AGC, “F-104” (trademark) provided by Daikin Industries, “6-J” (trademark) provided by Chemours-Mitsui Fluoroproducts, and the like.

The number average molecular weight of the polytetrafluoroethylene in the polytetrafluoroethylene powder may be 1,000,000 or more and 20,000,000 or less from such a viewpoint that the pore become excessively small during stretching and growth of a fibrous framework can be facilitated to be promoted while preventing cleavage of the porous membrane. Moreover, a second melting heat amount in the polytetrafluoroethylene powder may be 20 J/g or more and 45 J/g or less from such a viewpoint that it depends on the number average molecular weight of the polytetrafluoroethylene powder.

The parts by mass of the liquid lubricant may be 10 parts by mass or more and 40 parts by mass or less with respect to 100 parts by mass of the polytetrafluoroethylene powder. When the parts by mass of the liquid lubricant is less than 10 parts by mass, it tends to be difficult to perform extrusion. When the mass of the liquid lubricant is more than 40 parts by mass, it tends to be difficult to perform compression molding.

In addition to the polytetrafluoroethylene powder and the liquid lubricant, the other additive described above may be further used as a material of the kneaded material.

### <First-2-b Step>

The first-2-b step is performed by performing extrusion-molding onto the kneaded material so as to obtain the sheet-shaped molded body. More specifically, the kneaded material is subjected to extrusion molding to have a sheet shape at a temperature of the room temperature (for example, 25 °C) or more and 50 °C or less and at a rate of, for example, 10 mm/min or more and 30 mm/min or less, thereby obtaining a precursor of the sheet-shaped molded body. Further, the precursor is subjected to rolling with a calender roll or the like, thereby obtaining the sheet-shaped molded body having an average thickness of 0,200 mm or more and 0.400 mm or less. The average thickness can be specified in the same manner as in the above-described method of measuring the “thickness of porous membrane 1” except that the measurement is performed onto the molded body.

Further, the liquid lubricant included in the molded body may be removed before the below-described first-2-c step is performed. The liquid lubricant can be removed by performing heating, extraction, melting, or the like onto the molded body. When the heating is performed, for example, the liquid lubricant can be removed from the molded body by performing rolling onto the molded body using a hot roll of 130 °C or more and 220 °C or less. When a liquid lubricant having a relatively high boiling point such as silicone oil or fluorochlorocarbon oil is used as the liquid lubricant, the removal by extraction is preferable.

### <First-2-c Step>

The first-2-c step can be performed by uniaxially or biaxially stretching the molded body so as to obtain the stretched body. Since the first-2-c step is performed by uniaxially stretching the molded body in the production of any one of the support membranes included in the stacked body, “a ratio of an absolute value of a difference between the length X′in the MD direction and the length X in the MD direction with respect to the length X in the MD direction can be 10% or less in terms of percentage, and a ratio of an absolute value of a difference between the length Y′ in the TD direction and the length Y in the TD direction with respect to the length Y in the TD direction can be 5% or less in terms of percentage” while suppressing expansion of the pores and decrease of porosity due to the aggregation of the fiber of the porous membrane and allowing the average bubble point of the stacked body and the Gurley second of the stacked body to fall within the desired ranges. Here, the uniaxial stretching means that the molded body having the sheet shape is stretched in the MD direction (in other words, the flow direction of the molded body). The biaxial stretching means that the molded body having the sheet shape is stretched in the MD direction (in other words, the flow direction of the molded body) and the TD direction perpendicular to the MD direction.

The temperature in the first-2-c step may be 60 °C or more and 300 °C or less. When the temperature is more than 300 °C, the pore diameter of the support membrane tends to be too large (in other words, the average bubble point of the support membrane tends to be too small). When the temperature is less than 60 °C, the pore diameter tends to be too small (in other words, the average bubble point of the support membrane tends to be too large).

When the molded body having the sheet shape is stretched in the MD direction, a draw ratio in the MD direction may be 1.5 times or more and 20 times or less. It should be noted that the draw ratio in the MD direction means a value obtained by dividing the average length in the MD direction immediately after the stretching in the MD direction by the average length in the MD direction immediately before the stretching in the MD direction. When the draw ratio in the MD direction is less than 1.5 times, the thickness of the support membrane may fall out of the desired range. When the draw ratio in the MD direction is more than 20 times, the thickness of the support membrane may fall out of the desired range. It should be noted that here, the “average length in the MD direction” means the average value of lengths at any ten locations in the MD direction.

When the molded body having the sheet shape is stretched in the TD direction, a draw ratio in the TD direction may be 1.5 times or more and 100 times or less. It should be noted that the draw ratio in the TD direction means a value obtained by dividing the average length in the TD direction immediately after the stretching in the TD direction by the average length in the TD direction immediately before the stretching in the TD direction. When the draw ratio in the TD direction is less than 1.5 times, the thickness of the support membrane may fall out of the desired range. When the draw ratio in the TD direction is more than 100 times, the thickness of the support membrane may fall out of the desired range. It should be noted that here, the “average length in the TD direction” means the average value of lengths at any ten locations in the TD direction.

### <First-2-d Step>

The first-2-d step is performed by performing heat treatment onto the stretched body so as to obtain the support membrane.

The lower limit of the temperature in the first-2-d step may be 345 °C or more. When the temperature is less than 345 °C, the thermal stability of the stacked body tends to be decreased. The upper limit of the temperature in the first-2-d step may be 800 °C or less. When the temperature is more than 800 °C, the mechanical strength of the stacked body tends to be facilitated to be decreased due to thermal decomposition of polytetrafluoroethylene.

The lower limit of the time of the first-2-d step may be 0.01 minute or more. When the time is less than 0.01 minute, the thermal stability of the support membrane tends to be facilitated to be decreased. The upper limit of the time of the first-2-d step may be 120 minutes or less. When the time is more than 120 minutes, the mechanical strength of the support membrane tends to be facilitated to be decreased due to thermal decomposition of polytetrafluoroethylene.

### <<Second Step>>

The second step is performed by stacking the porous membranes and the support membranes. Examples of a method of stacking the porous membranes and the support membranes include a method of performing pressure bonding onto adjacent membranes of the support membranes and the porous membranes.

Specifically, as the method of performing pressure bonding onto adjacent membranes of the support membranes and the porous membranes, for example, the support membranes and the porous membranes are overlapped with each other so as to obtain a stacked body precursor. Next, the stacked body precursor is pressed by flat plates from above and below, or the stacked body precursor is sandwiched between rotation rollers from above and below and is then sent out. The method of performing pressure bonding onto the adjacent membranes of the support membranes and the porous membranes may be performed by performing the pressure bonding at 10 kgf or more and 2000 kgf or less. When the force is less than 10 kgf, adhesive force between the adjacent membranes of the support membranes and the porous membranes tends to be insufficient. When the force is more than 2000 kgf, the pores of the support membranes and the porous membranes are collapsed, with the result that the permeation efficiency tends to be facilitated to be decreased.

In this way, it is possible to obtain a stacked body comprising a porous membrane, wherein the porous membrane includes polytetrafluoroethylene as a main component, the stacked body has a sheet shape, an average bubble point P1a of the stacked body is 390 kPa or more, or an average bubble point P1b of the stacked body is 780 kPa or more, the average bubble point P1a is measured by a bubble point method using a first-a liquid, a surface tension of the first-a liquid is 13 mN/m, the average bubble point P1b is measured by a bubble point method using a first-b liquid, a surface tension of the first-b liquid is 21 mN/m, a Gurley second of the stacked body is 70 seconds or less, a length X of the stacked body in an MD direction of the stacked body before a test of placing the stacked body in a thermostatic chamber at 120 °C for 1 hour and a length X′ of the stacked body in the MD direction of the stacked body after the test satisfy a relation of the above-described formula 1, and a length Y of the stacked body in a TD direction of the stacked body before the test and a length Y′ of the stacked body in the TD direction of the stacked body after the test satisfy a relation of the above-described formula 2.

### Third Embodiment: Filter Element

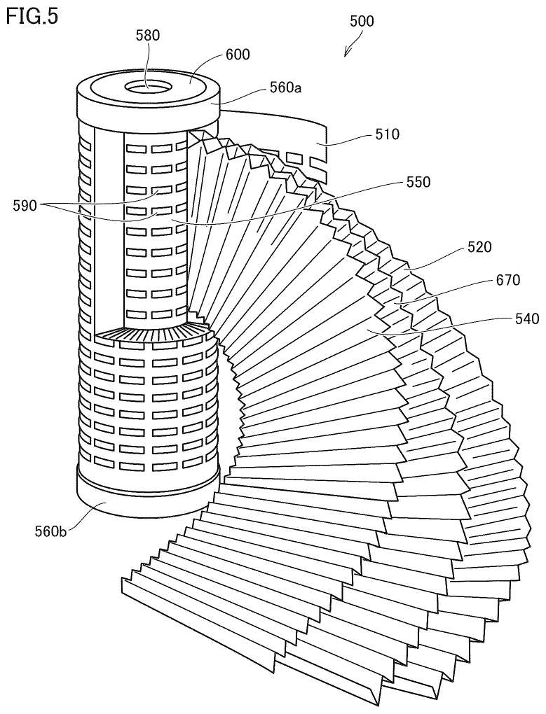

A filter element according to one embodiment of the present disclosure will be described with reference to FIG. 5. A filter element 500 according to the present embodiment includes a stacked body 670 according to the first embodiment.

Although filter element 500 according to the present embodiment is not particularly limited as long as filter element 500 includes stacked body 670 according to the first embodiment, stacked body 670 can have a pleated structure in filter element 500, for example.

According to the present disclosure, it is possible to provide a filter element comprising a stacked body having both excellent thermal stability and a high average bubble point and allowing for a high flow rate of filtrate.

FIG. 5 shows filter element 500 including stacked body 670 having the pleated structure. Stacked body 670 is pleated with stacked body 670 being sandwiched between two protective members 520, 540, and is wound around a core 550 having a large number of liquid collection ports 590. On a side external thereto, an outer peripheral guard 510 is present and protects stacked body 670. Stacked body 670 is sealed by end plates 560a, 560b at both ends of the cylinder. Each of the end plates is in contact with a sealing portion of a filter housing (not shown) with a gasket 600 being interposed therebetween. A filtered liquid is collected via liquid collection ports 590 of core 550 and is recovered from an outlet 580. Regarding the filter element, there have been known a filter element having outlets at its both ends and a filter element having an outlet at one end. Generally, in the case of the filter element having the outlets at its both ends, one end thereof is sealed by a jig, thereby recovering the filtered liquid from the outlet at the other end.

### Fourth Embodiment: Method of Producing Filter Element

A method of producing the filter element according to the present embodiment can be performed in the same manner as in a conventionally known method except that the stacked body according to the first embodiment is used.

### EXAMPLES

Hereinafter, explanation will be specifically made based on examples of the present disclosure, but the present invention is not limited to the following examples.

### Example 1

### <<Production of Stacked Body>>

Each of stacked bodies according to samples 1-1 to 1-4 and samples 1-101 to 1-103 was produced in the following manner.

### <Production of Porous Membrane>

### <First-1-a Step>

First, a “PTFE fine powder A (second melting heat amount of 15.8 J/g; molecular weight of about 28,000,000)”, which is a polytetrafluoroethylene powder, and “Supersol FP-25” (trademark), which is a solvent naphtha (liquid lubricant) provided by Idemitsu Sekiyu, were mixed in parts by mass shown in Table 1, thereby obtaining a mixture. Next, the mixture was subjected to compression molding to have a block shape by using a compression molding machine, thereby obtaining a kneaded material.

### <First-1-b Step>

The kneaded material was subjected to extrusion molding to have a sheet shape under conditions described in Table 1, thereby obtaining a precursor of a sheet-shaped molded body. Next, the precursor was subjected to rolling with a calender roll, thereby obtaining the sheet-shaped molded body having an average thickness as shown in Table 1.

### <First-1-c Step>

The molded body was biaxially stretched under conditions described in Table 1, thereby obtaining a stretched body.

### <First-1-d Step>

The stretched body was subjected to heat treatment under conditions described in Table 1, thereby obtaining the porous membrane.

In this way, the porous membranes according to samples 1-1 to 1-4 and samples 1-101 to 1-103 were produced.

### <Production of First Support Membrane>

### <First-2 Step>

A first support membrane was produced for each of samples 1-1 to 1-4 and samples 1-101 to 1-103 in the following manner. First, a “PTFE fine powder B (second melting heat amount of 26.5 J/g; molecular weight of about 4,000,000)”, which is a polytetrafluoroethylene powder, and “Supersol FP-25” (trademark), which is a solvent naphtha (liquid lubricant) provided by Idemitsu Sekiyu, were mixed in parts by mass shown in Table 2, thereby obtaining a mixture. Next, the mixture was subjected to compression molding to have a block shape by using a compression molding machine, thereby obtaining a kneaded material.

The kneaded material was subjected to extrusion molding to have a sheet shape under conditions shown in Table 2, thereby obtaining a precursor of a sheet-shaped molded body. Next, the precursor was subjected to rolling with a calender roll, thereby obtaining the sheet-shaped molded body having an average thickness as shown in Table 2.

The molded body was stretched under conditions shown in Table 2, thereby obtaining a stretched body.

The stretched body was subjected to heat treatment under conditions shown in Table 2, thereby obtaining the first support membrane, which is porous.

In this way, the first support membranes according to samples 1-1 to 1-4 and samples 1-101 to 1-103, each of which is porous, were prepared.

### <Production of Second Support Membrane>

### <First-2 Step>

A second support membrane was produced for each of samples 1-1 to 1-4 and samples 1-101 to 1-103 in the following manner. First, a “PTFE fine powder C (second melting heat amount of 26.0 J/g; molecular weight of about 5,000,000)”, which is a polytetrafluoroethylene powder, and “Supersol FP-25” (trademark), which is a solvent naphtha (liquid lubricant) provided by Idemitsu Sekiyu, were mixed in parts by mass shown in Table 3, thereby obtaining a mixture. Next, the mixture was subjected to compression molding to have a block shape by using a compression molding machine, thereby obtaining a kneaded material.

The kneaded material was subjected to extrusion molding to have a sheet shape under conditions shown in Table 3, thereby obtaining a precursor of a sheet-shaped molded body. Next, the precursor was subjected to rolling with a calender roll, thereby obtaining the sheet-shaped molded body having an average thickness as shown in Table 3.

The molded body was stretched under conditions shown in Table 3, thereby obtaining a stretched body.

The stretched body was subjected to heat treatment under conditions shown in Table 3, thereby obtaining the second support membrane, which is porous.

In this way, the second support membranes according to samples 1-1 to 1-4 and samples 1-101 to 1-103, each of which is porous, were prepared.

### <Second Step>

The first support membrane, the porous membrane, and the second support membrane were stacked in this order under conditions shown in Table 4, thereby obtaining a stacked body having a sheet shape.

In this way, each of stacked bodies according to samples 1-1 to 1-4 and samples 1-101 to 1-103 was produced.

TABLE 1

| | First-1 Step | | | | | | | | | | |
|---|---|---|---|---|---|---|---|---|---|---|---|
| | PTFE | Liquid | | | Average | MD Direction | | TD Direction | | | |
| | Powder | Lubricant | Extrusion Molding | | Thickness of | | Draw | | Draw | Heat Treatment | |
| Sample | [Parts by | [Parts by | Temperature | Rate | Molded Body | Temperature | Ratio | Temperature | Ratio | Temperature | Time |
| No. | Mass] | Mass] | [°C] | [mm/min] | [μm] | [°C] | [times] | [°C] | [times] | [°C] | [min] |
| 1-1 | 100 | 16 | 50 | 20 | 360 | 280 | 8.0 | 140 | 54 | 210 | 0.8 |
| 1-2 | 100 | 16 | 50 | 20 | 380 | 280 | 8.0 | 140 | 64 | 360 | 0.4 |
| 1-3 | 100 | 16 | 50 | 20 | 360 | 280 | 8.0 | 140 | 27 | 210 | 0.4 |
| 1-4 | 100 | 16 | 50 | 20 | 360 | 280 | 8.0 | 140 | 27 | 210 | 0.4 |
| 1-101 | 100 | 16 | 50 | 20 | 360 | 280 | 8.0 | 140 | 54 | 210 | 0.8 |
| 1-102 | 100 | 14 | 50 | 20 | 320 | 320 | 5.2 | 140 | 27 | 360 | 0.8 |
| 1-103 | 100 | 14 | 50 | 20 | 320 | 280 | 5.2 | 140 | 27 | 305 | 0.4 |

TABLE 2

| | First-2 Step (First Support Membrane) | | | | | | | | | | |
|---|---|---|---|---|---|---|---|---|---|---|---|
| | PTFE | Liquid | | | Average | MD Direction | | TD Direction | | | |
| | Powder | Lubricant | Extrusion Molding | | Thickness of | | Draw | | Draw | Heat Treatment | |
| Sample | [Parts by | [Parts by | Temperature | Rate | Molded Body | Temperature | Ratio | Temperature | Ratio | Temperature | Time |
| No. | Mass] | Mass] | [°C] | [mm/min] | [μm] | [°C] | [times] | [°C] | [times] | [°C] | [min] |
| 1-1 | 100 | 23 | 50 | 20 | 210 | 280 | 11 | — | — | 390 | 0.8 |
| 1-2 | 100 | 23 | 50 | 20 | 210 | 280 | 11 | — | — | 390 | 0.8 |
| 1-3 | 100 | 23 | 50 | 20 | 210 | 280 | 11 | — | — | 390 | 0.8 |
| 1-4 | 100 | 23 | 50 | 20 | 210 | 280 | 11 | — | — | 390 | 0.8 |
| 1-101 | 100 | 23 | 50 | 20 | 260 | 280 | 3 | 150 | 21 | 390 | 0.8 |
| 1-102 | 100 | 23 | 50 | 20 | 260 | 280 | 3 | 150 | 21 | 390 | 0.8 |
| 1-103 | 100 | 22 | 50 | 20 | 330 | 280 | 3 | 150 | 12 | 390 | 0.8 |

TABLE 3

| | First-2 Step (Second Support Membrane) | | | | | | | | | | |
|---|---|---|---|---|---|---|---|---|---|---|---|
| | PTFE | Liquid | | | Average | MD Direction | | TD Direction | | | |
| | Powder | Lubricant | Extrusion Molding | | Thickness of | | Draw | | Draw | Heat Treatment | |
| Sample | [Parts by | [Parts by | Temperature | Rate | Molded Body | Temperature | Ratio | Temperature | Ratio | Temperature | Time |
| No. | Mass] | Mass] | [°C] | [mm/min] | [μm] | [°C] | [times] | [°C] | [times] | [°C] | [min] |
| 1-1 | 100 | 23 | 50 | 20 | 210 | 280 | 11 | — | — | 390 | 0.8 |
| 1-2 | 100 | 23 | 50 | 20 | 210 | 280 | 11 | — | — | 390 | 0.8 |
| 1-3 | 100 | 23 | 50 | 20 | 210 | 280 | 11 | — | — | 390 | 0.8 |
| 1-4 | 100 | 23 | 50 | 20 | 210 | 280 | 11 | — | — | 390 | 0.8 |
| 1-101 | 100 | 23 | 50 | 20 | 260 | 280 | 3 | 150 | 21 | 390 | 0.8 |
| 1-102 | 100 | 23 | 50 | 20 | 260 | 280 | 3 | 150 | 21 | 390 | 0.8 |
| 1-103 | 100 | 22 | 50 | 20 | 330 | 280 | 3 | 150 | 12 | 390 | 0.8 |

TABLE 4

| | Second |
|---|---|
| | Step |
| | Pressure |
| | Bonding |
| Sample | Force |
| No. | [kgf] |
| 1-1 | 600 |
| 1-2 | 600 |
| 1-3 | 600 |
| 1-4 | 250 |
| 1-101 | 600 |
| 1-102 | 500 |
| 1-103 | 500 |

TABLE 5

| | First Support Membrane | | | | | | | | | | | |
|---|---|---|---|---|---|---|---|---|---|---|---|---|
| | | | | | | | | | Maximum | Maximum | [Maximum Tensile | |
| | | | | | | | | | Tensile | Tensile | Strength (MD | |
| | | | | | | | | Mean | Strength | Strength | Direction)]/ | Uniaxial |
| | PTFE | | Basis | | | | Gurley | Flow Pore | [MPa] | [MPa] | [Maximum Tensile | Stretching/ |
| Sample | Content | Thickness | Weight | Density | P3a | P3b | Second | Diameter | (MD | (TD | Strength (TD | Biaxial |
| No. | [mass %] | [mm] | [mg/mm²] | [g/cm³] | [kPa] | [kPa] | [s] | [nm] | Direction) | Direction) | Direction)] | Stretching |
| 1-1 | 100 | 0.023 | 0.0262 | 1.16 | 60 | 250 | 7 | 441 | 107.8 | 5.2 | 20.9 | Uniaxial |
| | | | | | | | | | | | | Stretching |
| 1-2 | 100 | 0.020 | 0.0231 | 1.16 | 60 | 250 | 7 | 441 | 107.8 | 5.2 | 20.9 | Uniaxial |
| | | | | | | | | | | | | Stretching |
| 1-3 | 100 | 0.024 | 0.0278 | 1.16 | 60 | 250 | 7 | 441 | 107.8 | 5.2 | 20.9 | Uniaxial |
| | | | | | | | | | | | | Stretching |
| 1-4 | 100 | 0.023 | 0.0266 | 1.16 | 60 | 250 | 7 | 441 | 107.8 | 5.2 | 20.9 | Uniaxial |
| | | | | | | | | | | | | Stretching |
| 1-101 | 100 | 0.008 | 0.0054 | 0.67 | 73 | 270 | 2 | 340 | 24.5 | 22.1 | 1.1 | Biaxial |
| | | | | | | | | | | | | Stretching |
| 1-102 | 100 | 0.011 | 0.0074 | 0.67 | 73 | 270 | 2 | 340 | 24.5 | 22.1 | 1.1 | Biaxial |
| | | | | | | | | | | | | Stretching |
| 1-103 | 100 | 0.011 | 0.0063 | 0.57 | 96 | 310 | 2 | 278 | 20.1 | 15.1 | 1.3 | Biaxial |
| | | | | | | | | | | | | Stretching |

TABLE 6

| | Porous Membrane | | | | | | | |
|---|---|---|---|---|---|---|---|---|
| | PTFE | | Basis | | | | Gurley | Mean Flow |
| Sample | Content | Thickness | Weight | Density | P2a | P2b | Second | Pore Diameter |
| No. | [mass %] | [mm] | [mg/mm²] | [g/cm³] | [kPa] | [kPa] | [s] | [nm] |
| 1-1 | 100 | 0.006 | 0.0037 | 0.60 | 452 | 894 | 15 | 52 |
| 1-2 | 100 | 0.005 | 0.0015 | 0.30 | 414 | 830 | 12 | 56 |
| 1-3 | 100 | 0.011 | 0.0030 | 0.28 | 605 | 1108 | 20 | 39 |
| 1-4 | 100 | 0.011 | 0.0030 | 0.28 | 605 | 1108 | 20 | 39 |
| 1-101 | 100 | 0.006 | 0.0035 | 0.58 | 452 | 894 | 15 | 52 |
| 1-102 | 100 | 0.010 | 0.0089 | 0.89 | 375 | 771 | 29 | 59 |
| 1-103 | 100 | 0.009 | 0.0030 | 0.33 | 479 | 938 | 19 | 54 |

TABLE 7

| | Second Support Membrane | | | | | | | | | | | |
|---|---|---|---|---|---|---|---|---|---|---|---|---|
| | | | | | | | | | Maximum | Maximum | [Maximum Tensile | |
| | | | | | | | | | Tensile | Tensile | Strength (MD | |
| | | | | | | | | Mean | Strength | Strength | Direction)]/ | Uniaxial |
| | PTFE | | Weight | | | | Gurley | Flow Pore | [MPa] | [MPa] | [Maximum Tensile | Stretching/ |
| Sample | Content | Thickness | Basis | Density | P3a | P3b | Second | Diameter | (MD | (TD | Strength (TD | Biaxial |
| No. | [mass %] | [mm] | [mg/mm²] | [g/cm³] | [kPa] | [kPa] | [s] | [nm] | Direction) | Direction) | Direction)] | Stretching |
| 1-1 | 100 | 0.023 | 0.0262 | 1.16 | 60 | 250 | 7 | 441 | 107.8 | 5.2 | 20.9 | Uniaxial |
| | | | | | | | | | | | | Stretching |
| 1-2 | 100 | 0.020 | 0.0231 | 1.16 | 60 | 250 | 7 | 441 | 107.8 | 5.2 | 20.9 | Uniaxial |
| | | | | | | | | | | | | Stretching |
| 1-3 | 100 | 0.024 | 0.0278 | 1.16 | 60 | 250 | 7 | 441 | 107.8 | 5.2 | 20.9 | Uniaxial |
| | | | | | | | | | | | | Stretching |
| 1-4 | 100 | 0.023 | 0.0266 | 1.16 | 60 | 250 | 7 | 441 | 107.8 | 5.2 | 20.9 | Uniaxial |
| | | | | | | | | | | | | Stretching |
| 1-101 | 100 | 0.008 | 0.0054 | 0.67 | 73 | 270 | 2 | 340 | 24.5 | 22.1 | 1.1 | Biaxial |
| | | | | | | | | | | | | Stretching |
| 1-102 | 100 | 0.011 | 0.0074 | 0.67 | 73 | 270 | 2 | 340 | 24.5 | 22.1 | 1.1 | Biaxial |
| | | | | | | | | | | | | Stretching |
| 1-103 | 100 | 0.011 | 0.0063 | 0.57 | 96 | 310 | 2 | 278 | 20.1 | 15.1 | 1.3 | Biaxial |
| | | | | | | | | | | | | Stretching |

TABLE 8

| | Stacked Body | | | | | | | | | | | |
|---|---|---|---|---|---|---|---|---|---|---|---|---|
| | | | | | | | | | | | (\|X′ − | (\|Y′ − |
| | | | | Mean | S1 | S2 | | | | | X\|/X) × 100 | Y\|/Y) × 100 |
| | | Basis | | Flow Pore | [MPa] | [MPa] | | | | Gurley | [%] | [%] |
| Sample | Thickness | Weight | Density | Diameter | (MD | (TD | | P1a | P1b | Second | (MD | (TD |
| No. | [mm] | [mg/mm²] | [g/cm³] | [nm] | Direction) | Direction) | S1/S2 | [kPa] | [kPa] | [s] | Direction) | Direction) |
| 1-1 | 0.052 | 0.0478 | 0.92 | 40 | 75.3 | 16.6 | 4.5 | 539 | 1037 | 28 | 6 | 1 |
| 1-2 | 0.045 | 0.0370 | 0.82 | 57 | 71.1 | 20.1 | 3.5 | 403 | 812 | 15 | 10 | 5 |
| 1-3 | 0.059 | 0.0507 | 0.86 | 34 | 74.6 | 17.2 | 4.31 | 772 | 1398 | 44 | 8 | 1 |
| 1-4 | 0.057 | 0.0507 | 0.88 | 36 | 74.9 | 14.9 | 5.01 | 624 | 1175 | 34 | 10 | 1 |
| 1-101 | 0.022 | 0.0150 | 0.67 | 42 | 50.6 | 50.3 | 1.0 | 459 | 902 | 21 | 20 | 24 |
| 1-102 | 0.032 | 0.0216 | 0.68 | 62 | 59.5 | 57.2 | 1.0 | 387 | 778 | 36 | 0 | 1 |
| 1-103 | 0.031 | 0.0350 | 1.13 | 39 | 49.6 | 44.9 | 1.1 | 542 | 11036 | 48 | 32 | 43 |

### <<Evaluation on Properties of Porous Membrane>>

The content of polytetrafluoroethylene, thickness, basis weight, density, average bubble point, Gurley second, and mean flow pore diameter of the porous membrane in the stacked body according to each sample were determined by the methods described in the first embodiment. The obtained results are shown in Table 6.

### <<Evaluation on Properties of Support Membrane>>

The content of polytetrafluoroethylene, thickness, maximum tensile strength, stretching direction, basis weight, density, average bubble point, Gurley second, and mean flow pore diameter of the first support membrane in the stacked body according to each sample were determined by the methods described in the first embodiment. The obtained results are shown in Table 5. The content of polytetrafluoroethylene, thickness, maximum tensile strength, stretching direction, basis weight, density, average bubble point, Gurley second, and mean flow pore diameter of the second support membrane in the stacked body according to each sample were determined by the methods described in the first embodiment. The obtained results are shown in Table 7. When “Uniaxial Stretching” is described in the column “Uniaxial Stretching/Biaxial Stretching”, it means that the support membrane is the “uniaxially stretched support membrane”, whereas when “Biaxial Stretching” is described therein, it means that the support membrane is the “biaxially stretched support membrane”.

### <<Evaluation on Properties of Stacked Body>>

The thickness, basis weight, density, mean flow pore diameter, maximum tensile strength, average bubble point, Gurley second, and each evaluation item of thermal stability test in the stacked body according to each sample were determined by the methods described in the “first embodiment”. The obtained results are shown in Table 8.

Each of the stacked bodies according to samples 1-1 to 1-4 corresponds to an example of the present disclosure. On the other hand, each of the stacked bodies according to samples 1-101 to 1-103 corresponds to a comparative example. Each of the stacked bodies according to samples 1-1 to 1-4 has a higher average bubble point than that of the stacked body according to sample 1-102.

A fact that the Gurley second of the stacked body is 70 seconds or less means that the stacked body exhibits a high flow rate of filtrate.

Each of the stacked bodies according to samples 1-1 to 1-4 exhibits a high flow rate of filtrate.

The fact that the ratio of the absolute value of the difference between the X′ and the X with respect to the X is 10% or less and the ratio of the absolute value of the difference between the Y′ and the Y with respect to the Y is 5% or less means that the thermal stability of the stacked body is excellent.

Each of the stacked bodies according to samples 1-1 to 1-4 has more particularly excellent thermal stability than that of each of the stacked bodies according to samples 1-101 and 103.

Therefore, each of the stacked bodies according to samples 1-1 to 1-4 exhibits a particularly excellent effect that both more excellent thermal stability and a higher average bubble point are achieved and a higher flow rate of filtrate is exhibited than those of each of the stacked bodies according to samples 1-101 and 1-103.

In view of the above, it was found that each of the stacked bodies according to samples 1-1 to 1-4 exhibits such a particularly excellent effect that both excellent thermal stability and a high average bubble point are achieved and a high flow rate of filtrate is exhibited.

### Example 2

### <<Production of Stacked Body>>

Stacked bodies according to samples 2-1 to 2-4 and samples 2-101 to 2-103 were produced in the following manner.

### <Production of Porous Membrane>

### <First-1-a Step>

First, a “PTFE fine powder A (second melting heat amount of 15.8 J/g; a molecular weight of about 28,000,000)”, which is a polytetrafluoroethylene powder, and “Supersol FP-25” (trademark), which is a solvent naphtha (liquid lubricant) provided by Idemitsu Sekiyu, were mixed in parts by mass shown in Table 9, thereby obtaining a mixture. Next, the mixture was subjected to compression molding to have a block shape by using a compression molding machine, thereby obtaining a kneaded material.

### <First-1-b Step>

The kneaded material was subjected to extrusion molding to have a sheet shape under conditions shown in Table 9, thereby obtaining a precursor of a sheet-shaped molded body. Next, the precursor was subjected to rolling with a calender roll, thereby obtaining the sheet-shaped molded body having an average thickness as shown in Table 9.

### <First-1-c Step>

The molded body was biaxially stretched under conditions shown in Table 9, thereby obtaining a stretched body.

### <First-1-d Step>

The stretched body was subjected to heat treatment under conditions shown in Table 9, thereby obtaining the porous membrane.

In this way, the porous membranes according to samples 2-1 to 2-4 and samples 2-101 to 2-103 were produced.

### <Production of First Support Membrane>

### <First-2 Step>

The first support membrane was produced for each of samples 2-1 to 2-4 and samples 2-101 to 2-103 in the following manner. First, a “PTFE fine powder B (second melting heat amount of 26.5 J/g; molecular weight of about 4,000,000)”, which is a polytetrafluoroethylene powder, and “Supersol FP-25” (trademark), which is a solvent naphtha (liquid lubricant) provided by Idemitsu Sekiyu, were mixed in parts by mass shown in Table 10, thereby obtaining a mixture. Next, the mixture was subjected to compression molding to have a block shape by using a compression molding machine, thereby obtaining a kneaded material.

The kneaded material was subjected to extrusion molding to have a sheet shape under conditions shown in Table 10, thereby obtaining a precursor of a sheet-shaped molded body. Next, the precursor was subjected to rolling with a calender roll, thereby obtaining the sheet-shaped molded body having an average thickness as shown in Table 10.

The molded body was stretched under conditions shown in Table 10, thereby obtaining a stretched body.

The stretched body was subjected to heat treatment under conditions shown in Table 10, thereby obtaining the first support membrane, which is porous.

In this way, the first support membranes according to samples 2-1 to 2-4 and samples 2-101 to 2-103, each of which is porous, were prepared.

### <Production of Second Support Membrane>

### <First-2 Step>

A second support membrane was produced for each of samples 2-1 to 2-4 and samples 2-101 to 2-103 in the following manner. First, a “PTFE fine powder C (second melting heat amount of 26.0 J/g; molecular weight of about 5,000,000)”, which is a polytetrafluoroethylene powder, and “Supersol FP-25” (trademark), which is a solvent naphtha (liquid lubricant) provided by Idemitsu Sekiyu, were mixed in parts by mass shown in Table 11, thereby obtaining a mixture. Next, the mixture was subjected to compression molding to have a block shape by using a compression molding machine, thereby obtaining a kneaded material.

The kneaded material was subjected to extrusion molding to have a sheet shape under conditions shown in Table 11, thereby obtaining a precursor of a sheet-shaped molded body. Next, the precursor was subjected to rolling with a calender roll, thereby obtaining the sheet-shaped molded body having an average thickness as shown in Table 11.

The molded body was stretched under conditions shown in Table 11, thereby obtaining a stretched body.

The stretched body was subjected to heat treatment under conditions shown in Table 11, thereby obtaining the second support membrane, which is porous.

In this way, the second support membranes according to samples 2-1 to 2-4 and samples 2-101 to 2-103, each of which is porous, were prepared.

### <Production of Third Support Membrane>

### <First-2 Step>

A third support membrane was produced for each of samples 2-1 to 2-4 and samples 2-101 to 2-103 in the following manner. First, a “PTFE fine powder C (second melting heat amount of 26.0 J/g; molecular weight of about 5,000,000)”, which is a polytetrafluoroethylene powder, and “Supersol FP-25” (trademark), which is a solvent naphtha (liquid lubricant) provided by Idemitsu Sekiyu, were mixed in parts by mass shown in Table 12, thereby obtaining a mixture. Next, the mixture was subjected to compression molding to have a block shape by using a compression molding machine, thereby obtaining a kneaded material.

The kneaded material was subjected to extrusion molding to have a sheet shape under conditions shown in Table 12, thereby obtaining a precursor of a sheet-shaped molded body. Next, the precursor was subjected to rolling with a calender roll, thereby obtaining the sheet-shaped molded body having an average thickness as shown in Table 12.

The molded body was stretched under conditions shown in Table 12, thereby obtaining a stretched body.

The stretched body was subjected to heat treatment under conditions shown in Table 12, thereby obtaining the third support membrane, which is porous.

In this way, the third support membranes according to samples 2-1 to 2-4 and samples 2-101 to 2-103, each of which is porous, were prepared.

### <Production of Fourth Support Membrane>

### <First-2 Step>

A fourth support membrane was produced for each of samples 2-1 to 2-4 and samples 2-101 to 2-103 in the following manner. First, a “PTFE fine powder B (second melting heat amount of 26.5 J/g; molecular weight of about 4,000,000)”, which is a polytetrafluoroethylene powder, and “Supersol FP-25” (trademark), which is a solvent naphtha (liquid lubricant) provided by Idemitsu Sekiyu, were mixed in parts by mass shown in Table 13, thereby obtaining a mixture. Next, the mixture was subjected to compression molding to have a block shape by using a compression molding machine, thereby obtaining a kneaded material.

The kneaded material was subjected to extrusion molding to have a sheet shape under conditions shown in Table 13, thereby obtaining a precursor of a sheet-shaped molded body. Next, the precursor was subjected to rolling with a calender roll, thereby obtaining the sheet-shaped molded body having an average thickness as shown in Table 13.

The molded body was stretched under conditions shown in Table 13, thereby obtaining a stretched body.

The stretched body was subjected to heat treatment under conditions shown in Table 13, thereby obtaining the fourth support membrane, which is porous.

In this way, the fourth support membranes according to samples 2-1 to 2-4 and samples 2-101 to 2-103, each of which is porous, were prepared.

### <Second Step>

The first support membrane, the second support membrane, the porous membrane, the third support membrane, and the fourth support membrane were stacked in this order under conditions shown in Table 14, thereby obtaining a stacked body having a sheet shape.

In this way, each of stacked bodies according to samples 2-1 to 2-4 and samples 2-101 to 2-103 was produced.

TABLE 9

| | First-1 Step | | | | | | | | | | |
|---|---|---|---|---|---|---|---|---|---|---|---|
| | PTFE | Liquid | | | Average | MD Direction | | TD Direction | | | |
| | Powder | Lubricant | Extrusion Molding | | Thickness of | | Draw | | Draw | Heat Treatment | |
| Sample | [Parts by | [Parts by | Temperature | Rate | Molded Body | Temperature | Ratio | Temperature | Ratio | Temperature | Time |
| No. | Mass] | Mass] | [°C] | [mm/min] | [μm] | [°C] | [times] | [°C] | [times] | [°C] | [min] |
| 2-1 | 100 | 16 | 50 | 20 | 360 | 280 | 8.0 | 140 | 54.0 | 210 | 0.8 |
| 2-2 | 100 | 16 | 50 | 20 | 360 | 280 | 8.0 | 140 | 54.0 | 210 | 0.8 |
| 2-3 | 100 | 16 | 50 | 20 | 380 | 280 | 8.0 | 140 | 49.0 | 210 | 0.8 |
| 2-4 | 100 | 14 | 50 | 20 | 360 | 280 | 8.0 | 140 | 27.0 | 210 | 0.8 |
| 2-101 | 100 | 16 | 50 | 20 | 360 | 280 | 8.0 | 140 | 54.0 | 210 | 0.8 |
| 2-102 | 100 | 18 | 50 | 20 | 320 | 280 | 6.0 | 140 | 25.0 | 210 | 0.8 |
| 2-103 | 100 | 16 | 50 | 20 | 360 | 280 | 8.0 | 140 | 54.0 | 210 | 0.8 |

TABLE 10

| | First-2 Step (First Support Membrane) | | | | | | | | | | |
|---|---|---|---|---|---|---|---|---|---|---|---|
| | PTFE | Liquid | | | Average | MD Direction | | TD Direction | | | |
| | Powder | Lubricant | Extrusion Molding | | Thickness of | | Draw | | Draw | Heat Treatment | |
| Sample | [Parts by | [Parts by | Temperature | Rate | Molded Body | Temperature | Ratio | Temperature | Ratio | Temperature | Time |
| No. | Mass] | Mass] | [°C] | [mm/min] | [μm] | [°C] | [times] | [°C] | [times] | [°C] | [min] |
| 2-1 | 100 | 23 | 50 | 20 | 210 | 280 | 11 | — | — | 390 | 0.8 |
| 2-2 | 100 | 23 | 50 | 20 | 260 | 280 | 3 | 150 | 21 | 390 | 0.8 |
| 2-3 | 100 | 23 | 50 | 20 | 210 | 280 | 11 | — | — | 390 | 0.8 |
| 2-4 | 100 | 19 | 50 | 20 | 210 | 280 | 11 | — | — | 390 | 0.8 |
| 2-101 | 100 | 23 | 50 | 20 | 260 | 280 | 3 | 150 | 21 | 390 | 0.8 |
| 2-102 | 100 | 23 | 50 | 20 | 260 | 280 | 3 | 150 | 21 | 390 | 0.8 |
| 2-103 | 100 | 19 | 50 | 20 | 500 | 280 | 3 | 150 | 13 | 390 | 0.8 |

TABLE 11

| | First-2 Step (Second Support Membrane) | | | | | | | | | | |
|---|---|---|---|---|---|---|---|---|---|---|---|
| | PTFE | Liquid | | | Average | MD Direction | | TD Direction | | | |
| | Powder | Lubricant | Extrusion Molding | | Thickness of | | Draw | | Draw | Heat Treatment | |
| Sample | [Parts by | [Parts by | Temperature | Rate | Molded Body | Temperature | Ratio | Temperature | Ratio | Temperature | Time |
| No. | Mass] | Mass] | [°C] | [mm/min] | [μm] | [°C] | [times] | [°C] | [times] | [°C] | [min] |
| 2-1 | 100 | 23 | 50 | 20 | 260 | 280 | 3 | 150 | 21 | 390 | 0.8 |
| 2-2 | 100 | 23 | 50 | 20 | 210 | 280 | 11 | — | — | 390 | 0.8 |
| 2-3 | 100 | 23 | 50 | 20 | 260 | 280 | 3 | 150 | 21 | 390 | 0.8 |
| 2-4 | 100 | 23 | 50 | 20 | 260 | 280 | 3 | 150 | 21 | 390 | 0.8 |
| 2-101 | 100 | 23 | 50 | 20 | 260 | 280 | 3 | 150 | 21 | 390 | 0.8 |
| 2-102 | 100 | 23 | 50 | 20 | 260 | 280 | 3 | 150 | 21 | 390 | 0.8 |
| 2-103 | 100 | 19 | 50 | 20 | 500 | 280 | 3 | 150 | 13 | 390 | 0.8 |

TABLE 12

| | First-2 Step (Third Support Membrane) | | | | | | | | | | |
|---|---|---|---|---|---|---|---|---|---|---|---|
| | PTFE | Liquid | | | Average | MD Direction | | TD Direction | | | |
| | Powder | Lubricant | Extrusion Molding | | Thickness of | | Draw | | Draw | Heat Treatment | |
| Sample | [Parts by | [Parts by | Temperature | Rate | Molded Body | Temperature | Ratio | Temperature | Ratio | Temperature | Time |
| No. | Mass] | Mass] | [°C] | [mm/min] | [μm] | [°C] | [times] | [°C] | [times | [°C] | [min] |
| 2-1 | 100 | 23 | 50 | 20 | 260 | 280 | 3 | 150 | 21 | 390 | 0.8 |
| 2-2 | 100 | 23 | 50 | 20 | 210 | 280 | 11 | — | — | 390 | 0.8 |
| 2-3 | 100 | 23 | 50 | 20 | 260 | 280 | 3 | 150 | 21 | 390 | 0.8 |
| 2-4 | 100 | 23 | 50 | 20 | 260 | 280 | 3 | 150 | 21 | 390 | 0.8 |
| 2-101 | 100 | 23 | 50 | 20 | 260 | 280 | 3 | 150 | 21 | 390 | 0.8 |
| 2-102 | 100 | 23 | 50 | 20 | 260 | 280 | 3 | 150 | 21 | 390 | 0.8 |
| 2-103 | 100 | 19 | 50 | 20 | 500 | 280 | 3 | 150 | 13 | 390 | 0.8 |

TABLE 13

| | First-2 Step (Fourth Support Membrane) | | | | | | | | | | |
|---|---|---|---|---|---|---|---|---|---|---|---|
| | PTFE | Liquid | | | Average | MD Direction | | TD Direction | | | |
| | Powder | Lubricant | Extrusion Molding | | Thickness of | | Draw | | Draw | Heat Treatment | |
| Sample | [Parts by | [Parts by | Temperature | Rate | Molded Body | Temperature | Ratio | Temperature | Ratio | Temperature | Time |
| No. | Mass] | Mass] | [°C] | [mm/min] | [μm] | [°C] | [times] | [°C] | [times] | [°C] | [min] |
| 2-1 | 100 | 23 | 50 | 20 | 210 | 280 | 11 | — | — | 390 | 0.8 |
| 2-2 | 100 | 23 | 50 | 20 | 260 | 280 | 3 | 150 | 21 | 390 | 0.8 |
| 2-3 | 100 | 23 | 50 | 20 | 210 | 280 | 11 | — | — | 390 | 0.8 |
| 2-4 | 100 | 19 | 50 | 20 | 210 | 280 | 11 | — | — | 390 | 0.8 |
| 2-101 | 100 | 23 | 50 | 20 | 260 | 280 | 3 | 150 | 21 | 390 | 0.8 |
| 2-102 | 100 | 23 | 50 | 20 | 260 | 280 | 3 | 150 | 21 | 390 | 0.8 |
| 2-103 | 100 | 19 | 50 | 20 | 500 | 280 | 3 | 150 | 13 | 390 | 0.8 |

TABLE 14

| | Second Step |
|---|---|
| | Pressure |
| | Bonding |
| Sample | Force |
| No. | [kgf] |
| 2-1 | 600 |
| 2-2 | 600 |
| 2-3 | 600 |
| 2-4 | 600 |
| 2-101 | 600 |
| 2-102 | 600 |
| 2-103 | 600 |

TABLE 15

| | First Support Membrane | | | | | | | | | | | |
|---|---|---|---|---|---|---|---|---|---|---|---|---|
| | | | | | | | | | Maximum | Maximum | [Maximum Tensile | |
| | | | | | | | | | Tensile | Tensile | Strength (MD | |
| | | | | | | | | Mean | Strength | Strength | Direction)]/ | Uniaxial |
| | PTFE | | Basis | | | | Gurley | Flow Pore | [MPa] | [MPa] | [Maximum Tensile | Stretching/ |
| Sample | Content | Thickness | Weight | Density | P3a | P3b | Second | Diameter | (MD | (TD | Strength (TD | Biaxial |
| No. | [mass %] | [mm] | [mg/mm²] | [g/cm³] | [kPa] | [kPa] | [s] | [nm] | Direction) | Direction) | Direction)] | Stretching |
| 2-1 | 100 | 0.027 | 0.0312 | 1.16 | 60 | 250 | 7 | 441 | 107.8 | 5.2 | 20.9 | Uniaxial |
| | | | | | | | | | | | | Stretching |
| 2-2 | 100 | 0.009 | 0.0060 | 0.67 | 73 | 270 | 2 | 340 | 24.5 | 22.1 | 1.1 | Biaxial |
| | | | | | | | | | | | | Stretching |
| 2-3 | 100 | 0.025 | 0.0289 | 1.16 | 60 | 250 | 7 | 441 | 107.8 | 5.2 | 20.9 | Uniaxial |
| | | | | | | | | | | | | Stretching |
| 2-4 | 100 | 0.030 | 0.0406 | 1.35 | 112 | 335 | 13 | 156 | 120.7 | 6.1 | 19.8 | Uniaxial |
| | | | | | | | | | | | | Stretching |
| 2-101 | 100 | 0.008 | 0.0054 | 0.67 | 73 | 270 | 2 | 340 | 24.5 | 22.1 | 1.1 | Biaxial |
| | | | | | | | | | | | | Stretching |
| 2-102 | 100 | 0.008 | 0.0054 | 0.67 | 73 | 270 | 2 | 340 | 24.5 | 22.1 | 1.1 | Biaxial |
| | | | | | | | | | | | | Stretching |
| 2-103 | 100 | 0.022 | 0.0164 | 0.74 | 205 | 488 | 19 | 126 | 40.0 | 54.2 | 0.7 | Biaxial |
| | | | | | | | | | | | | Stretching |

TABLE 16

| | Second Support Membrane | | | | | | | | | | | |
|---|---|---|---|---|---|---|---|---|---|---|---|---|
| | | | | | | | | | Maximum | Maximum | [Maximum Tensile | |
| | | | | | | | | | Tensile | Tensile | Strength (MD | |
| | | | | | | | | Mean | Strength | Strength | Direction)]/ | Uniaxial |
| | PTFE | | Basis | | | | Gurley | Flow Pore | [MPa] | [MPa] | [Maximum Tensile | Stretching/ |
| Sample | Content | Thickness | Weight | Density | P3a | P3b | Second | Diameter | (MD | (TD | Strength (TD | Biaxial |
| No. | [mass %] | [mm] | [mg/mm²] | [g/cm³] | [kPa] | [kPa] | [s] | [nm] | Direction) | Direction) | Direction)] | Stretching |
| 2-1 | 100 | 0.009 | 0.0060 | 0.67 | 73 | 270 | 2 | 340 | 24.5 | 22.1 | 1.1 | Biaxial |
| | | | | | | | | | | | | Stretching |
| 2-2 | 100 | 0.027 | 0.0312 | 1.16 | 60 | 250 | 7 | 441 | 107.8 | 5.2 | 20.9 | Uniaxial |
| | | | | | | | | | | | | Stretching |
| 2-3 | 100 | 0.008 | 0.0054 | 0.67 | 73 | 270 | 2 | 340 | 24.5 | 22.1 | 1.1 | Biaxial |
| | | | | | | | | | | | | Stretching |
| 2-4 | 100 | 0.010 | 0.0067 | 0.67 | 73 | 270 | 2 | 340 | 24.5 | 22.1 | 1.1 | Biaxial |
| | | | | | | | | | | | | Stretching |
| 2-101 | 100 | 0.008 | 0.0054 | 0.67 | 73 | 270 | 2 | 340 | 24.5 | 22.1 | 1.1 | Biaxial |
| | | | | | | | | | | | | Stretching |
| 2-102 | 100 | 0.008 | 0.0054 | 0.67 | 73 | 270 | 2 | 340 | 24.5 | 22.1 | 1.1 | Biaxial |
| | | | | | | | | | | | | Stretching |
| 2-103 | 100 | 0.022 | 0.0164 | 0.74 | 205 | 488 | 19 | 126 | 40.0 | 54.2 | 0.7 | Biaxial |
| | | | | | | | | | | | | Stretching |

TABLE 17

| | Porous Membrane | | | | | | | |
|---|---|---|---|---|---|---|---|---|
| | | | | | | | | Mean |
| | PTFE | | Basis | | | | Gurley | Flow Pore |
| Sample | Content | Thickness | Weight | Density | P2a | P2b | Second | Diameter |
| No. | [mass %] | [mm] | [mg/mm²] | [g/cm³] | [kPa] | [kPa] | [s] | [nm] |
| 2-1 | 100 | 0.005 | 0.0030 | 0.60 | 495 | 963 | 16 | 53 |
| 2-2 | 100 | 0.004 | 0.0024 | 0.60 | 495 | 963 | 16 | 53 |
| 2-3 | 100 | 0.008 | 0.0049 | 0.61 | 509 | 986 | 20 | 52 |
| 2-4 | 100 | 0.012 | 0.0157 | 1.31 | 604 | 1141 | 26 | 41 |
| 2-101 | 100 | 0.005 | 0.0030 | 0.60 | 495 | 963 | 16 | 53 |
| 2-102 | 100 | 0.009 | 0.0091 | 1.01 | 331 | 693 | 22 | 74 |
| 2-103 | 100 | 0.006 | 0.0037 | 0.60 | 495 | 963 | 16 | 53 |

TABLE 18

| | Third Support Membrane | | | | | | | | | | | |
|---|---|---|---|---|---|---|---|---|---|---|---|---|
| | | | | | | | | | Maximum | Maximum | [Maximum Tensile | |
| | | | | | | | | | Tensile | Tensile | Strength (MD | |
| | | | | | | | | Mean | Strength | Strength | Direction)]/ | Uniaxial |
| | PTFE | | Weight | | | | Gurley | Flow Pore | [MPa] | [MPa] | Maximum Tensile | Stretching/ |
| Sample | Content | Thickness | Basis | Density | P3a | P3b | Second | Diameter | (MD | (TD | Strength (TD | Biaxial |
| No. | [mass %] | [mm] | [mg/mm²] | [g/cm³] | [kPa] | [kPa] | [s] | [nm] | Direction) | Direction) | Direction)] | Stretching |
| 2-1 | 100 | 0.009 | 0.0060 | 0.67 | 73 | 270 | 2 | 340 | 24.5 | 22.1 | 1.1 | Biaxial |
| | | | | | | | | | | | | Stretching |
| 2-2 | 100 | 0.027 | 0.0312 | 1.16 | 60 | 250 | 7 | 441 | 107.8 | 5.2 | 20.9 | Uniaxial |
| | | | | | | | | | | | | Stretching |
| 2-3 | 100 | 0.008 | 0.0054 | 0.67 | 73 | 270 | 2 | 340 | 24.5 | 22.1 | 1.1 | Biaxial |
| | | | | | | | | | | | | Stretching |
| 2-4 | 100 | 0.010 | 0.0067 | 0.67 | 73 | 270 | 2 | 340 | 24.5 | 22.1 | 1.1 | Biaxial |
| | | | | | | | | | | | | Stretching |
| 2-101 | 100 | 0.008 | 0.0054 | 0.67 | 73 | 270 | 2 | 340 | 24.5 | 22.1 | 1.1 | Biaxial |
| | | | | | | | | | | | | Stretching |
| 2-102 | 100 | 0.008 | 0.0054 | 0.67 | 73 | 270 | 2 | 340 | 24.5 | 22.1 | 1.1 | Biaxial |
| | | | | | | | | | | | | Stretching |
| 2-103 | 100 | 0.022 | 0.0164 | 0.74 | 205 | 488 | 19 | 126 | 40.0 | 54.2 | 0.7 | Biaxial |
| | | | | | | | | | | | | Stretching |

TABLE 19

| | Fourth Support Membrane | | | | | | | | | | | |
|---|---|---|---|---|---|---|---|---|---|---|---|---|
| | | | | | | | | | Maximum | Maximum | [Maximum Tensile | |
| | | | | | | | | | Tensile | Tensile | Strength (MD | |
| | | | | | | | | Mean | Strength | Strength | Direction)]/ | Uniaxial |
| | PTFE | | Basis | | | | Gurley | Flow Pore | [MPa] | [MPa] | [Maximum Tensile | Stretching/ |
| Sample | Content | Thickness | Weight | Density | P3a | P3b | Second | Diameter | (MD | (TD | Strength (TD | Biaxial |
| No. | [mass %] | [mm] | [mg/mm²] | [g/cm³] | [kPa] | [kPa] | [s] | [nm] | Direction) | Direction) | Direction)] | Stretching |
| 2-1 | 100 | 0.027 | 0.0312 | 1.16 | 60 | 250 | 7 | 441 | 107.8 | 5.2 | 20.9 | Uniaxial |
| | | | | | | | | | | | | Stretching |
| 2-2 | 100 | 0.009 | 0.0060 | 0.67 | 73 | 270 | 2 | 340 | 24.5 | 22.1 | 1.1 | Biaxial |
| | | | | | | | | | | | | Stretching |
| 2-3 | 100 | 0.025 | 0.0289 | 1.16 | 60 | 250 | 7 | 441 | 107.8 | 5.2 | 20.9 | Uniaxial |
| | | | | | | | | | | | | Stretching |
| 2-4 | 100 | 0.030 | 0.0406 | 1.35 | 112 | 335 | 13 | 156 | 120.7 | 6.1 | 19.8 | Uniaxial |
| | | | | | | | | | | | | Stretching |
| 2-101 | 100 | 0.008 | 0.0054 | 0.67 | 73 | 270 | 2 | 340 | 24.5 | 22.1 | 1.1 | Biaxial |
| | | | | | | | | | | | | Stretching |
| 2-102 | 100 | 0.008 | 0.0054 | 0.67 | 73 | 270 | 2 | 340 | 24.5 | 22.1 | 1.1 | Biaxial |
| | | | | | | | | | | | | Stretching |
| 2-103 | 100 | 0.022 | 0.0164 | 0.74 | 205 | 488 | 19 | 126 | 40.0 | 54.2 | 0.7 | Biaxial |
| | | | | | | | | | | | | Stretching |

TABLE 20

| | Stacked Body | | | | | | | | | | | |
|---|---|---|---|---|---|---|---|---|---|---|---|---|
| | | | | | | | | | | | (\|X′ − | (\|Y′ − |
| | | | | Mean | S1 | S2 | | | | | X\|/X) × 100 | Y\|/Y) × 100 |
| | | Basis | | Flow Pore | [MPa] | [MPa] | | | | Gurley | [%] | [%] |
| Sample | Thickness | Weight | Density | Diameter | (MD | (TD | | P1a | P1b | Second | (MD | (TD |
| No. | [mm] | [mg/mm²] | [g/cm³] | [nm] | Direction) | Direction) | S1/S2 | [kPa] | [kPa] | [s] | Direction) | Direction) |
| 2-1 | 0.077 | 0.0746 | 0.97 | 37 | 76.2 | 15.1 | 5.0 | 616 | 1161 | 38 | 4 | 0 |
| 2-2 | 0.076 | 0.0699 | 0.92 | 41 | 72.7 | 15.6 | 4.7 | 391 | 794 | 41 | 5 | 2 |
| 2-3 | 0.074 | 0.0660 | 0.89 | 34 | 75.1 | 14.5 | 5.2 | 646 | 210 | 54 | 4 | 0 |
| 2-4 | 0.092 | 0.0745 | 0.81 | 31 | 59.4 | 18.6 | 3.2 | 747 | 1378 | 70 | 10 | 5 |
| 2-101 | 0.037 | 0.0150 | 0.67 | 41 | 33.3 | 28.8 | 1.2 | 593 | 1122 | 25 | 16 | 14 |
| 2-102 | 0.041 | 0.0164 | 0.40 | 71 | 71.7 | 70.8 | 1.0 | 349 | 740 | 32 | 15 | 12 |
| 2-103 | 0.094 | 0.0885 | 0.94 | 44 | 57.2 | 60.5 | 0.9 | 591 | 1120 | 105 | 14 | 10 |

### <<Evaluation on Properties of Porous Membrane>>

The content of polytetrafluoroethylene, thickness, basis weight, density, average bubble point, Gurley second, and mean flow pore diameter of the porous membrane in the stacked body according to each sample were determined by the method described in the first embodiment. The obtained results are shown in Table 17.

### <<Evaluation on Properties of Support Membrane>>

The content of polytetrafluoroethylene, thickness, maximum tensile strength, stretching direction, basis weight, density, average bubble point, Gurley second, and mean flow pore diameter of each of the first to fourth support membranes in the stacked bodies according to the respective samples were determined by the methods described in the first embodiment. The obtained results are shown in Tables 15 to 19.

### <<Evaluation on Properties of Stacked Body>>

The thickness, basis weight, density, mean flow pore diameter, maximum tensile strength, average bubble point, Gurley second, and each evaluation items of thermal stability test in the stacked body according to each sample were determined by the methods described in the first embodiment. The obtained results are shown in Table 20.

Each of the stacked bodies according to samples 2-1 to 2-4 corresponds to an example of the present disclosure. On the other hand, each of the stacked bodies according to samples 2-101 to 2-103 corresponds to a comparative example. Each of the stacked bodies according to samples 2-1 to 2-4 has a higher average bubble point than that of the stacked body according to 2-102.

A fact that the Gurley second is 70 seconds or less means that the stacked body exhibits a high flow rate of filtrate.

The stacked bodies according to samples 2-1 to 2-4 show a higher flow rate of filtrate than the stacked body according to 2-103.

The fact that the ratio of the absolute value of the difference between the X′ and the X with respect to the X is 10% or less and the ratio of the absolute value of the difference between the Y′ and the Y with respect to the Y is 5% or less means that the thermal stability of the stacked body is excellent.

Each of the stacked bodies according to samples 2-1 to 2-4 has more particularly excellent thermal stability than that of each of the stacked bodies according to samples 2-101 to 2-103.

Therefore, each of the stacked bodies according to samples 2-1 to 2-4 exhibits a particularly excellent effect that both more excellent thermal stability and a higher average bubble point are achieved and a higher flow rate of filtrate is exhibited than those of each of the stacked bodies according to samples 2-101 to 2-103.

In view of the above, it was found that each of the stacked bodies according to samples 2-1 to 2-4 exhibits such a particularly excellent effect that both excellent thermal stability and a high average bubble point are achieved and a high flow rate of filtrate is exhibited.

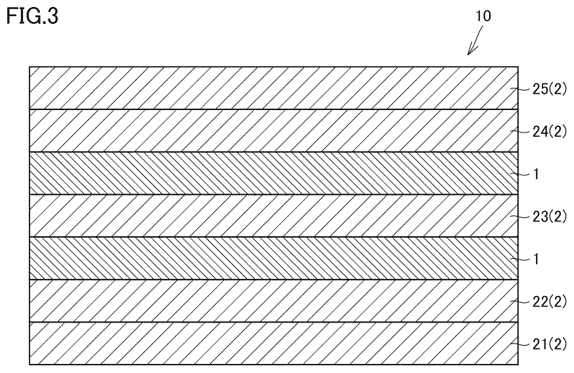

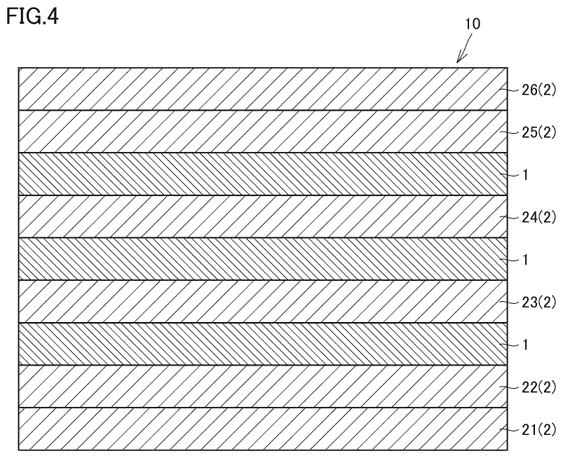

It should be noted that Examples 1 and 2 above only illustrate: the stacked body in which “the support membrane consists of the first support membrane and the second support membrane, and the porous membrane and the second support membrane are disposed on the first support membrane in this order”; and the stacked body in which “the support membrane consists of the first support membrane, the second support membrane, the third support membrane, and the fourth support membrane, and the second support membrane, the porous membrane, the third support membrane, and the fourth support membrane are disposed on the first support membrane in this order”. However, it is expected to exhibit the same effect in each of stacked bodies shown in, for example, (i) and (ii) below due to such a relation that porous membranes and biaxially stretched support membranes are alternately stacked and a uniaxially stretched support membrane is located on the surface of the stacked body as long as “a stacked body comprising a porous membrane, wherein the porous membrane includes polytetrafluoroethylene as a main component, the stacked body has a sheet shape, an average bubble point P1a of the stacked body is 390 kPa or more, or an average bubble point P1b of the stacked body is 780 kPa or more, the average bubble point P1a is measured by a bubble point method using a first-a liquid, a surface tension of the first-a liquid is 13 mN/m, the average bubble point P1b is measured by a bubble point method using a first-b liquid, a surface tension of the first-b liquid is 21 mN/m, a Gurley second of the stacked body is 70 seconds or less, a length X of the stacked body in an MD direction of the stacked body before a test of placing the stacked body in a thermostatic chamber at 120 °C for 1 hour and a length X′ of the stacked body in the MD direction of the stacked body after the test satisfy a relation of the above-described formula 1, and a length Y of the stacked body in a TD direction of the stacked body before the test and a length Y′ of the stacked body in the TD direction of the stacked body after the test satisfy a relation of the above-described formula 2”.
(i) A stacked body (FIG. 3) in which the porous membrane consists of a first porous membrane and a second porous membrane, the support membrane consists of a first support membrane, a second support membrane, a third support membrane, a fourth support membrane, and a fifth support membrane, the second support membrane, the first porous membrane, the third support membrane, the second porous membrane, the fourth support membrane, and the fifth support membrane are disposed on the first support membrane in this order, each of the second support membrane, the third support membrane, and the fourth support membrane is a biaxially stretched support membrane, and each of the first support membrane and the fifth support membrane is a uniaxially stretched support membrane.
(ii) A stacked body (FIG. 4) in which the porous membrane consists of a first porous membrane, a second porous membrane, and a third porous membrane, the support membrane consists of a first support membrane, a second support membrane, a third support membrane, a fourth support membrane, a fifth support membrane, and a sixth support membrane, the second support membrane, the first porous membrane, the third support membrane, the second porous membrane, the fourth support membrane, the third porous membrane, the fifth support membrane, and the sixth support membrane are disposed on the first support membrane in this order, and each of the second support membrane, the third support membrane, the fourth support membrane, and the fifth support membrane is a biaxially stretched support membrane, and each of 9231136 the first support membrane and the sixth support membrane is a uniaxially stretched support membrane.

The embodiments disclosed herein are illustrative and non-restrictive in any respect. The scope of the present invention is defined by the terms of the claims, rather than the embodiments described above, and is intended to include any modifications within the scope and meaning equivalent to the terms of the claims.

### REFERENCE SIGNS LIST

1 porous membrane; 2 support membrane; 10 stacked body; 21 first support membrane; 22 second support membrane; 23 third support membrane; 24 fourth support membrane; 25 fifth support membrane; 26 sixth support membrane; 500 filter element; 520, 540 protective member; 590 liquid collection port; 550 core; 510 outer peripheral guard; 560a, 560b end plate; 600 gasket; 580 outlet; 670 stacked body.

1. A stacked body comprising a porous membrane, wherein
the porous membrane includes polytetrafluoroethylene as a main component,
the stacked body has a sheet shape,
an average bubble point P1a of the stacked body is 390 kPa or more, or
an average bubble point P1b of the stacked body is 780 kPa or more,
the average bubble point P1a is measured by a bubble point method using a first-a liquid,
a surface tension of the first-a liquid is 13 mN/m,
the average bubble point P1b is measured by a bubble point method using a first-b liquid,
a surface tension of the first-b liquid is 21 mN/m,
a Gurley second of the stacked body is 70 seconds or less,
a length X of the stacked body in an MD direction of the stacked body before a test of placing the stacked body in a thermostatic chamber at 120 °C for 1 hour and a length X′ of the stacked body in the MD direction of the stacked body after the test satisfy a relation of the following formula 1, and
a length Y of the stacked body in a TD direction of the stacked body before the test and a length Y′ of the stacked body in the TD direction of the stacked body after the test satisfy a relation of the following formula 2:

|X′−X|/X≤0.10 Formula 1

|Y′−Y|/Y≤0.05 Formula 2.

2. The stacked body according to claim 1, wherein
the stacked body has a maximum tensile strength S1 in the MD direction and a maximum tensile strength S2 in the TD direction, and
the maximum tensile strength S1 in the MD direction and the maximum tensile strength S2 in the TD direction satisfy a relation of the following formula 3:
3.2≤S1/S2≤5.0 Formula 3.

3. The stacked body according to claim 1, further comprising a support membrane, wherein
the support membrane is porous, and
the support membrane includes polytetrafluoroethylene as a main component.

4. The stacked body according to claim 3, wherein
the support membrane consists of a first support membrane and a second support membrane,
the porous membrane and the second support membrane are disposed on the first support membrane in this order, and
each of the first support membrane and the second support membrane is a uniaxially stretched support membrane.

5. The stacked body according to claim 3, wherein
the support membrane consists of a first support membrane, a second support membrane, a third support membrane, and a fourth support membrane,
the second support membrane, the porous membrane, the third support membrane, and the fourth support membrane are disposed on the first support membrane in this order,
each of the second support membrane and the third support membrane is a biaxially stretched support membrane, and
each of the first support membrane and the fourth support membrane is a uniaxially stretched support membrane.

6. A filter element comprising the stacked body according to claim 1.
